(19) United States
(12) Patent Application Publication
(10) Pub. No.: US 2025/0113836 A1
(43) Pub. Date: Apr. 10, 2025

(54) SYSTEM AND METHOD FOR PROCESSING WORKPIECES

(71) Applicant: John Bean Technologies Corporation, Chicago, IL (US)

(72) Inventors: George R. Blaine, Lake Stevens, WA (US); Richard D. Stockard, San Diego, CA (US); Robert Holloman Walker, Deltaville, VA (US); Ashley S. Brill, Madison, NJ (US)

(73) Assignee: John Bean Technologies Corporation, Chicago, IL (US)

(21) Appl. No.: 18/910,988

(22) Filed: Oct. 9, 2024

Related U.S. Application Data
(60) Provisional application No. 63/588,917, filed on Oct. 9, 2023.

(51) Int. Cl. A22C 17/00; G06T 17/10; G06V 10/25; G06V 10/26; G06V 10/82

(52) U.S. Cl. CPC A22C 17/0086; A22C 17/0006; G06T 17/10; G06V 10/25; G06V 10/26; G06V 10/82

(57) ABSTRACT

A computer-implemented method of optimizing machine processing of a workpiece may include receiving, by a computing device, at least one sensor input regarding a workpiece; performing, by a computing device, pre-processing of the at least one sensor input for at least one of efficient transfer to another computing device and optimal use in one or more machine learning models; executing, by a computing device, one or more machine learning models to output requested information regarding the workpiece based on data in the at least one sensor input; processing, by a computing device, the output; and controlling at least one aspect of the machine processing of the workpiece, by a computing device, in response to the processed output.

### CROSS-REFERENCE TO RELATED APPLICATION

This application claims the benefit of U.S. Provisional Application No. 63/588,917, filed Oct. 9, 2023, the entire contents of which are incorporated herein by reference.

### BACKGROUND

Much of the portioning/trimming of workpieces, in particular food products, is now carried out with the use of high-speed portioning machines. These machines use various sensors to ascertain parameters of the food product as it is being advanced on a moving conveyor. The sensor information is analyzed with the aid of a computer to determine how to most efficiently and accurately process the food product (e.g., how to portion the food product into optimum sizes, how to trim the product (e.g., locating the fat for trimming), how to harvest the product (e.g., sort and/or pickup products of various sizes for further processing or packaging), etc.). For example, a customer may desire chicken breast portions in two different weight sizes, but with no fat or with a limited amount of acceptable fat. The chicken breast is scanned as it moves on an infeed conveyor belt and a determination is made through the use of a computer as to how best to portion the chicken breast to the weights desired by the customer, with no or limited amount of fat, so as to use the chicken breast most effectively.

Portioning and/or trimming of workpieces can be carried out by various cutting devices, including high-speed liquid jet cutters (liquids may include, for example, water or liquid nitrogen) or rotary or reciprocating blades, after the food product is transferred from the infeed to a cutting conveyor. In many high-speed portioning systems, several high-speed waterjet cutters are positioned along the length of a conveyor to achieve high throughput of the portioned/cut workpieces. Once the portioning/trimming has occurred, the resulting portions are off-loaded from the cutting conveyor and placed on a take-away conveyor for further processing or, perhaps, to be placed in a storage bin.

Although the high-speed portioning machines referenced herein are highly sophisticated for analyzing workpieces and for determining how to optimally portion or cut such workpieces at high production rates (e.g., typically over 200 pieces per minute), variations in shapes, dimensions, weights, densities, colors, and textures of incoming, raw, unprocessed food products cannot always be accounted for. Moreover, even if the portioner machines are frequently re-calibrated, the machine can quickly become out of sync (e.g., due to component wear, timing issues, etc.)

Workpieces, including food products, are portioned or otherwise cut into smaller pieces by processors in accordance with customer needs. The first division of a carcass is into primal cuts. More specifically, a primal cut or cut of meat is a piece of meat initially separated from the carcass of an animal during butchering or processing. Examples of primal cuts include the round, loin, rib, and chuck for beef or the ham, loin, Boston butt, and picnic for pork. Primal cuts are then divided into subprimal cuts. Examples of sub-primal cuts of beef are the top round, whole tenderloin, and rib eye, and examples of sub-primal cuts of pork are the sirloin chop, center loin chop, center rib chop, and rib end chop.

Processing sub-primal cuts may vary depending on the type of sub-primal cut. For instance, certain types of sub-primal cuts may be portioned or trimmed in accordance with customer specifications or other requirements specific to that cut type. Moreover, certain types of sub-primal cuts may be used in certain end products depending on, for instance, supply and demand of the types of sub-primal cuts.

### SUMMARY

In some aspects, the techniques described herein relate to a computer-implemented method of optimizing machine processing of a workpiece, the method including: receiving, by a computing device, at least one sensor input regarding a workpiece; performing, by a computing device, pre-processing of the at least one sensor input for at least one of efficient transfer to another computing device and optimal use in one or more machine learning models; executing, by a computing device, one or more machine learning models to output requested information regarding the workpiece based on data in the at least one sensor input; receiving and processing, by a computing device, the output; and controlling at least one aspect of the machine processing of the workpiece, by a computing device, in response to the processed output.

In some aspects, the techniques described herein relate to a system, including: a machine computing device, including: at least one processor and a non-transitory computer-readable medium; wherein the non-transitory computer-readable medium has computer-executable instructions stored thereon; and wherein the instructions, in response to execution by the at least one processor, cause the machine computing device to perform actions including: generating at least one sensor input related to machine processing of a workpiece; and an edge computing device, including: at least one processor and a non-transitory computer-readable medium; wherein the non-transitory computer-readable medium has computer-executable instructions stored thereon; wherein the instructions, in response to execution by the at least one processor, cause the edge computing device to perform actions including: receiving the at least one sensor input from the machine computing device; executing one or more machine learning models to output requested information regarding the workpiece based on data in the at least one sensor input; and wherein the instructions of the machine computing device, in response to execution by the at least one processor, cause the machine computing device to perform actions further including: receiving and processing the output; and controlling at least one aspect of the machine processing of the workpiece in response to the processed output.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a block diagram of a non-limiting example of a food processing management system according to various aspects of the present disclosure.

FIG. 2 shows a schematic illustration of a non-limiting example of a food processing management system 102 according to various aspects of the present disclosure.

FIG. 3 shows a block diagram of a non-limiting example of a machine computing device according to various aspects of the present disclosure.

FIG. 4 shows a screenshot of various images generated from one or more scanning devices of the food processing management system assembly according to various aspects of the present disclosure.

FIG. 5 shows a block diagram of a non-limiting example of a data processing computing device according to various aspects of the present disclosure.

FIG. 6 shows, from left to right, exemplary images of “butterfly,” “left,” and “right” chicken portions for use as training (when labeled) and/or input to a workpiece classification machine learning model.

FIG. 7 shows an exemplary output image of an image segmentation machine learning model showing beef rib segmentation of a beef rack of ribs.

FIG. 8 shows an exemplary output image of an image segmentation machine learning model showing rib and brisket bone segmentation for pork spare ribs.

FIG. 9A shows an exemplary output image of an image segmentation machine learning model showing a poultry thigh segmentation.

FIG. 9B shows an exemplary supplemental training data image for an image segmentation machine learning model showing a method for optimizing cut lines of a poultry thigh.

FIG. 10 shows an exemplary output image of an image segmentation machine learning model showing a chicken portion outline excluding extraneous fat and stringy pieces.

FIG. 11 shows an exemplary input (original) image of a T-bone steak on the left and an exemplary output image of an image segmentation machine learning model showing various identified features/regions of the T-bone steak on the right.

FIG. 12 shows an exemplary output image of an image segmentation machine learning model showing various identified features/regions of a steak.

FIG. 13 shows an exemplary output image of an ROI machine learning model showing a peak height area of a chicken breast.

FIG. 14 shows various exemplary input (original) images of a steak on the left and corresponding exemplary preliminary output mask images of an ROI machine learning model showing a predicted fatty region containing the sciatic nerve of the steak on the right, with mask images showing the actual fatty region containing the sciatic nerve of the steak in the middle.

FIG. 15 shows various exemplary geometric training data augmentations used for an ROI machine learning model configured to predict a predicted fatty region containing a sciatic nerve of a steak, with exemplary augmented input (original) images of a steak on the left and corresponding exemplary augmented output mask images of an ROI machine learning model showing a predicted fatty region containing the sciatic nerve of the steak on the right.

FIG. 16 shows an exemplary mask image resulting from a first post-processing algorithm step for processing an ROI machine learning model output configured to predict a predicted fatty region containing a sciatic nerve of a steak.

FIG. 17 shows an exemplary mask image resulting from a next post-processing algorithm step for processing an ROI machine learning model output configured to predict a predicted fatty region containing a sciatic nerve of a steak.

FIG. 18 shows an exemplary mask image resulting from a next post-processing algorithm step for processing an ROI machine learning model output configured to predict a predicted fatty region containing a sciatic nerve of a steak.

FIG. 19 shows an exemplary labeled training data image resulting from a pre-processing step for processing an ROI machine learning model output configured to predict a predicted fatty region containing a sciatic nerve of a steak.

FIG. 20 shows an exemplary mask image resulting from a next pre-processing step for processing an ROI machine learning model output configured to predict a predicted fatty region containing a sciatic nerve of a steak.

FIG. 21 is a block diagram that illustrates a non-limiting example of a computing device appropriate for use as a computing device with examples of the present disclosure.

### DETAILED DESCRIPTION

Systems and methods described herein relate to techniques for optimizing workpiece data processing without compromising data processing speed. In fact, using the systems and methods described herein, the accuracy and/or relevance of workpiece processing data is increased while also typically increasing workpiece data processing speed.

As noted above, workpieces may be processed on a machine like a high-speed portioning machine. These machines use various sensors to ascertain data pertaining to a workpiece, such as for instance, a size, shape, and height of the workpiece, features within the workpiece (e.g., bone location), etc., as it is being advanced on a moving conveyor. The sensor information is typically analyzed with the aid of a machine computer to determine how to most efficiently and accurately machine process the food product (e.g., portioning, trimming, harvesting, sorting, etc.). For instance, one or more software modules are executed on the machine computer to analyze the sensor data. Based on the analysis, the software modules output instructions to a controller of the portioner to machine process the workpiece as needed.

Because the workpieces must be machine processed (e.g., portioned) at a high speed to support necessary throughput, the total computer data processing time available for a workpiece is limited. As a non-limiting example, to support a throughput of 200 portioned/trimmed chicken filets per minute, a computing device must typically receive the sensor data, analyze the sensor data, and output instructions to the portioner controller within 100-300 ms. Thus, in most high-speed workpiece machine processing applications, the machine processing system employs an on-board machine computer that can receive and output data quickly.

On-board computers associated with workpiece processing machines, such as high-speed portioners, are not equipped with the processing power to run sophisticated image processing or recognition tools. As such, the image processing carried out by the on-board machine computer is limited.

Workpiece processing management systems and methods disclosed herein include the implementation of a local, high power computing device, also known as an “edge computing device”, that can receive input sensor data for a workpiece from a sensor associated with the processing machine, process the sensor data, and output requested workpiece data related to the input sensor data in a manner that enables more accurate or otherwise optimized machine processing of the workpiece. At the same time, the total data processing time using the systems and methods disclosed herein is not only within the allotted total data processing time available for the machine, but much lower in total data processing time compared to prior art methods.

The exemplary workpiece processing management systems and methods disclosed herein, though specifically applicable to food products or food items, may also be used outside of the food area. Accordingly, the present disclosure may reference “work products”, “workpieces,” etc., which terms are synonymous with each other. It is to be understood that references to work products and workpieces also include food, food products, food pieces, and food items, and references to food, food products, food pieces, food items, pieces, portions, or the like also include work products and workpieces.

Further, references to “food,” “food products,” “food pieces,” and “food items,” are used interchangeably and are meant to include all manner of foods. Such foods may include meat, fish, poultry, plant-based products, fruits, vegetables, nuts, or other types of foods. Also, the systems and methods described herein are directed to raw food products, as well as partially and/or fully processed or cooked food products.

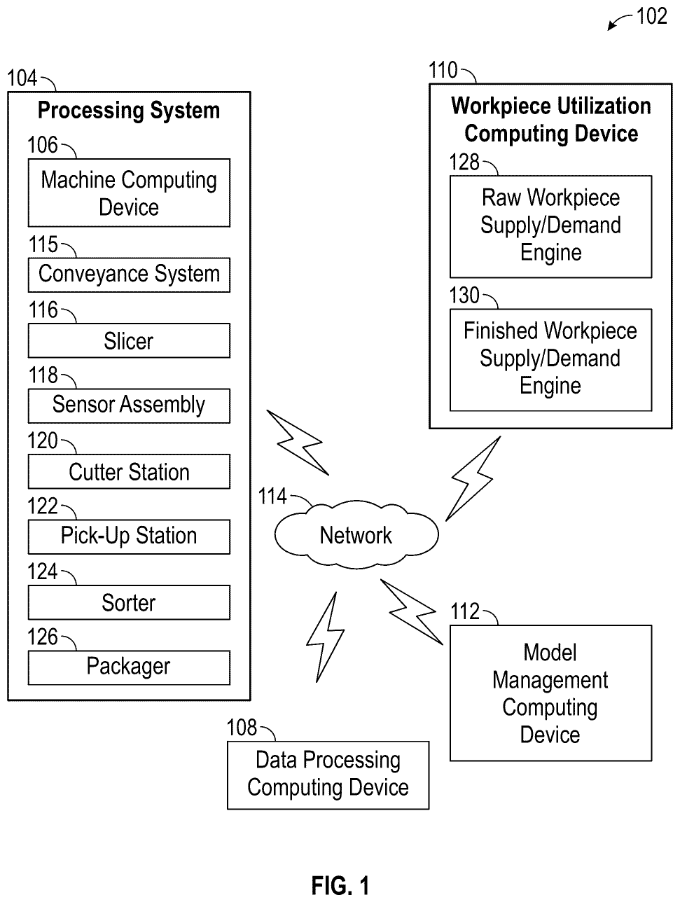

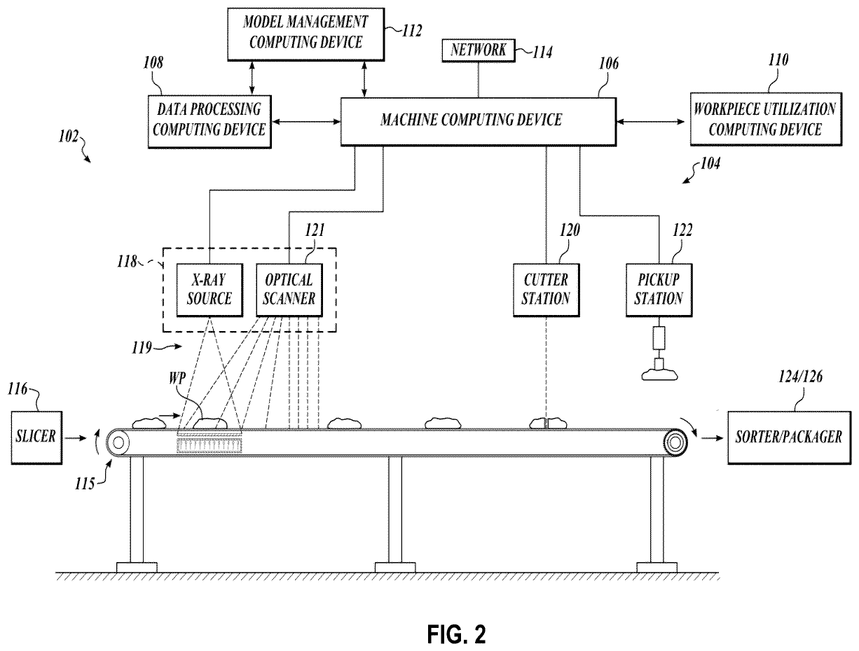

Referring to FIG. 1 and FIG. 2, a non-limiting example of a food processing management system 102 will now be described. Generally, the food processing management system 102 can be used to gather and process workpiece data and/or machine data for assessing one or more attributes of a food product processed by a food processing system 104 (or “workpiece processing system 104”) and/or to be machine processed, and/or one or more attributes of the processing system for supporting machine processing of the food product. The food processing management system 102 may include various networked computing devices configured for carrying out aspects of gathering and processing data for assessing one or more attributes of the food product/machine and carrying out aspects of processing the food product or managing the machine.

In the depicted example, the food processing management system 102 includes the workpiece processing system 104 having a machine computing device 106, a data processing computing device 108, a model management computing device 112, and a workpiece utilization computing device 110 communicatively coupled together through a network 114.

The machine computing device 106 may be a local/integrated computing device configured to control aspects of the workpiece processing system 104. The data processing computing device 108 may be a local, high power computing device or an edge computing device that is configured to process data sent from the machine computing device 106 over the network 114. The model management computing device 112 may be configured to receive machine learning model training data and generate machine learning models for sending/uploading to the data processing computing device 108. The workpiece utilization computing device 110 may be a computing device configured to generate and send workpiece supply/demand data to the machine computing device 106 for use in optimizing processing of workpieces. The network 114 can be any kind of network capable of enabling communication between the various components of the food processing management system 102. For example, the network can be a WiFi network.

Though a single data processing computing device 108 and a single machine computing device 106/workpiece processing system 104 are illustrated for the sake of simplicity, this is a non-limiting example only. In some examples, a single data processing computing device 108 may be associated with multiple computing devices 106/processing systems 104. Further, in some examples, a single computing device 106/workpiece processing system 104 may be associated with more than one data processing computing device 108 and/or more than one model management computing device 112 and/or more than one workpiece utilization computing device 110.

An exemplary workpiece processing system 104 will first be described with reference to FIGS. 1 and 2. The workpiece processing system 104 is generally configured to carry out machine processing of a food product. In that regard, the workpiece processing system 104 includes a conveyance system 115 or another movement device configured to carry workpieces WP, or food products between various portions of the workpiece processing system 104. For instance, the conveyance system 115 may carry the food products between one or more of a slicer 116, a sensor assembly 118, a cutter station 120, a pick-up station 122, a sorter 124, and a packager 126. The various components of the workpiece processing system 104 may be controlled by the machine computing device 106.

The conveyance system 115 may include at least one powered conveyor belt. Each powered conveyor belt is supported on vertical metal slats and/or wear strips and is wrapped around and moved by a series of rollers (not labeled), one of which is the drive roller, which drives the belts in a standard manner. An encoder may be employed with respect to a support roller or an end roller to determine the position of the food product on the conveyor belt as well as the progress or movement of the food product in the conveyance direction.

The powered conveyor belt may be, for instance, a flat, solid belt to support the food product during scanning by a scanning station of the sensor assembly 118. Such belts are typically flat, non-metallic belts. If a second powered conveyor belt is used, it may be configured to support the food product during the portioning or trimming process at cutter station 120. If a waterjet cutter is used to portion or trim the food product, it is advantageous to utilize an open mesh, metallic belt as the second powered conveyor belt to allow the waterjet to pass downwardly therethrough. Further, a metallic belt is of sufficient structural integrity to withstand the impact thereon from the waterjet. Such metallic, open mesh belts are articles of commerce.

Although first and second powered conveyor belts are described, the conveyance system 115 may be composed of only a single powered conveyor belt as shown. Using the systems and methods described herein, any required scan data can beneficially be captured when the food product is supported by a metallic belt, such as an open mesh, metallic belt.

However, in some examples, multiple powered conveyor belts are used for processing food products in a gap defined between the belts. For instance, elongated metal powered conveyor belts may be placed side by side, with an elongated gap (e.g., 1″) extending therebetween (substantially parallel to the longitudinal axes of the side by side belts). When processing retail chicken pieces or portions, for instance, the keel strip of each breast may be centered over the gap. When cut from the chicken portion, the keel strip will fall through the gap in the belts and require no difficult harvesting to separate it from any remaining trimmed rib meat, fat and fillets. As another example, the pin bones may be cut/separated from fish fillets with the pin bones over a conveyor belt gap such that the pin bones fall through the belt. In that regard, although not shown, another cutter station may be placed above the conveyance system 115 for processing any food products above a conveyor belt gap or the like.

The slicer 116 may be used to slice a primal product (e.g., a cut of meat initially separated from the carcass of an animal during butchering or processing, such as a pork loin) into a sub-primal product (such as a sirloin chop, center loin chop, center rib chop, and rib end chop for a pork loin) before being further processing by workpiece processing system 104. In that regard, the slicer 116 may be located downstream from a cutter (not shown) used to cut a carcass into primal cuts. The slicer 116 may also be used to cut a sub-primal cut, such as a pork chop or a chicken breast, into slices.

Various types of slicers may be utilized to slice the food product into one or more desired thicknesses of cuts or slices. For example, the slicer may be in the form of a high-speed water jet, a laser, a rotary saw, a hacksaw, or band saw. Also, the slicer may be adjustable so that a desired thickness of each cut or slice is obtained. Such adjustment may be managed by a controller, such as the machine computing device 106. For example, the slicer may be adjusted based on data sent from the data processing computing device 108 and processed by the machine computing device 106, such as to account for different characteristics of the food product (e.g., bone/fat/nerve/etc. location, product categorization/classification, density values (e.g., if a higher density is determined, a smaller slice may be made to achieve a slice within a weight spec), etc.).

In some examples, the workpiece processing system 104 receives cut or sliced products from another machine or location, and the slicer 116 is excluded. Generally, the terms “slicing”, “portioning”, “cutting”, ‘trimming”, or the like may include any type of, or any combination of, product cutting (e.g., slicing alone, portioning alone, or any other type of product cutting, and any combination of slicing, portioning, and other type of product cutting).

The workpieces WP or food products may be inspected by a sensor assembly 118 having one or more sensors used to capture sensor data pertaining to physical parameters/characteristics of the food products. Such physical parameters may include the maximum, average, mean, and/or medium values of such parameters.

Such parameters/characteristics may include, for example, size, shape, and/or height of the food products. For instance, sensors may be used to gather data regarding a length, width, length/width aspect ratio, thickness, thickness profile, contour, outer contour configuration, outer taper, flatness, outer perimeter configuration, outer perimeter size and shape, volume, weight, as well as whether the food products contain any undesirable materials, such as bones, fat, cartilage, metal, glass, plastic, etc., and the location of the undesirable materials in the food products. With respect to the thickness profile of the food product, such profile can be along the length of the food product, across the width of the food product, as well as both across/along the width and length of the food product.

The parameter referred to as the “perimeter” of the food product refers to the boundary or distance around a food product. Thus, the terms outer perimeter, outer perimeter configuration, outer perimeter size, and outer perimeter shape pertain to the distance around, the configuration, the size and the shape of the outermost boundary or edge of the food product.

The foregoing enumerated size and/or shape parameters/characteristics are not intended to be limiting or inclusive. Data regarding other size and/or shape parameters/characteristics may be ascertained by the sensor assembly 118 and used with the present systems and methods for machine processing the foods products. Moreover, the definitions or explanations of the above specific size and/or shape parameters/characteristics discussed above are not meant to be limiting or inclusive.

The sensor assembly 118 may include one or more scanners for capturing image data of the food products. For instance, one or more of the scanners and/or systems and methods for processing scanner data described in U.S. Pat. No. 10,721,947, entitled “Apparatus for acquiring and analysing product-specific data for products of the food processing industry as well as a system comprising such an apparatus and a method for processing products of the food processing industry,” hereby incorporated by reference herein in its entirety, may be used.

In the depicted example, the sensor assembly 118 may utilize an x-ray apparatus 119 for capturing image data determining the physical characteristics of the food product, including its shape, mass, and weight. X-rays may be passed through the object in the direction of an x-ray detector (not labeled). Such x-rays are attenuated by the food product in proportion to the mass thereof. The x-ray detector is capable of measuring the intensity of the x-rays received thereby, after passing through the food product.

The x-ray image data may be utilized to determine physical parameters pertaining to the size and/or shape of the food product, including for example, the length, width, aspect ratio, thickness, thickness profile, contour, outer contour configuration, perimeter, outer perimeter configuration, outer perimeter size and/or shape, volume, weight, as well as other aspects of the physical parameters/characteristics of the food product. With respect to the outer perimeter configuration of the food product, the X-ray detector can determine locations along the outer perimeter of the food product based on an X-Y coordinate system or other coordinate system. An example of such x ray scanning devices are disclosed in U.S. Pat. No. 5,585,605, entitled “Optical-scanning system employing laser and laser safety control”, U.S. Pat. No. 10,654,185, entitled “Cutting/portioning using combined X-ray and optical scanning”, U.S. Pat. No. 5,585,603, entitled “Method and system for weighing objects using X-rays”, as well as U.S. Pat. No. 10,721,947 (referenced above), incorporated herein by reference in their entirety.

The sensor assembly 118 may also include an optical scanner 121 for generating at least one of a visible light (e.g., greyscale) image, a laser light scattering image, a height map, a hyperspectral image, a multispectral image, etc., of the food product to show one or more of the overall shape/size of the food product, a composition of the food product (e.g., fat. v. lean meat), a height or thickness over the area of the food product, etc. Scanning with the optical scanner 121 can be carried out using a variety of techniques, such as the techniques shown and described in U.S. Pat. No. 10,654,185 as well as U.S. Pat. No. 10,721,947 (both referenced above), incorporated by reference herein.

The optical scanner 121 may include a video camera (not shown) to view a food product illuminated by one or more light sources. Light from the light source is extended across the moving conveyor belt to define a sharp shadow or light stripe line, with the area forwardly of the transverse beam being dark. When no food product is being carried by the conveyor belt, the shadow line/light stripe forms a straight line across the belt. However, when a food product passes across the shadow line/light stripe, the upper, irregular surface of the food product produces an irregular shadow line/light stripe as viewed by a video camera (not shown) directed diagonally downwardly on the food product and the shadow line/light stripe. The video camera detects the displacement of the shadow line/light stripe from the position it would occupy if no food product were present on the conveyor belt. This displacement represents the thickness of the food product along the shadow line/light stripe.

The length of the food product is determined by the distance of the belt travel that shadow line/light stripes are created by the food product. In this regard, an encoder, integrated into the conveyance system 115, generates pulses at fixed distance intervals corresponding to the forward movement of the conveyor.

In some examples, the optical scanner 121 is a single SICK® camera with a single laser light source that is suitable for capturing optical data and generating two or more images/views based on the optical data. For instance, the single camera may be in communication with a separate processor (having or more feature recognition modules or the like) and/or the machine computing device 106 for generating one or more views from the captured optical data, such as a fat recognition (FRS) object view, a laser scatter object view, and a height mode object view.

In some examples at least two optical cameras each equipped with a different imaging processor are used. For example, a simple optical camera, for example a greyscale camera, and/or RGB camera and/or IR and/or UV camera and/or a charge coupled device (CCD) and/or a Time-of-Flight (ToF) stereoscopic camera, a stereo camera, a lidar sensor, a structured light sensor, or the like, or combinations thereof, can be used to acquire and/or generate one or more complete images of the workpiece for detecting certain characteristics, such as, e.g., the outer contour of the workpiece. Moreover, a second, special camera, for example a multispectral or hyperspectral camera, can be used to acquire images/data of specific regions or characteristics of the workpiece, such as blood spots, streaks of fat or the like. It should be appreciated that a single camera/scanner may instead be used to capture all the data needed to generate the various images, such as with various imaging processes.

The sensor assembly 118 may also be used to capture aspects of the machine itself, such as aspects of the conveyance system 115. For instance, one or more optical sensors, e.g., cameras of the sensor assembly 118 may capture images of the conveyor system 115, including the links, chains, pins, or other components. Images of the conveyance system 115 may be used to assess belt sag, belt wear, or other issues or information that can affect food product processing accuracy.

The sensor assembly 118 may also include any other suitable sensors for capturing data pertaining to the workpieces (e.g., food products) and/or pertaining to the workpiece processing system 104, such as the conveyance system 115. For instance, the sensor assembly 118 may also include one or more of a weight measurement assembly (such as a scale), a temperature sensor (e.g., thermal imaging cameras, infrared thermometers, thermocouples, resistance thermometers such as Resistance Temperature Detectors (RTDs),), a stereo and color camera, such as for capturing still images (e.g., Intel RealSense D405), microphones, an optical encoder assembly, etc.

In one example, a high-speed optical micrometer, such as an TM-X5000 Series Telecentric Measurement System and/or an LS-9000 Series High-speed Optical Micrometer available from Keyence Corporation of America, may be used to perform inline, contact-free, highly accurate measurement of conveyance system components, such as pins, belt pickets or rods, links, chains, mesh components, etc. Such a high-speed optical micrometer can be used to generate measured values of objects, such as a diameter of a pin, a distance between belt pickets or rods, a height of the links, etc.

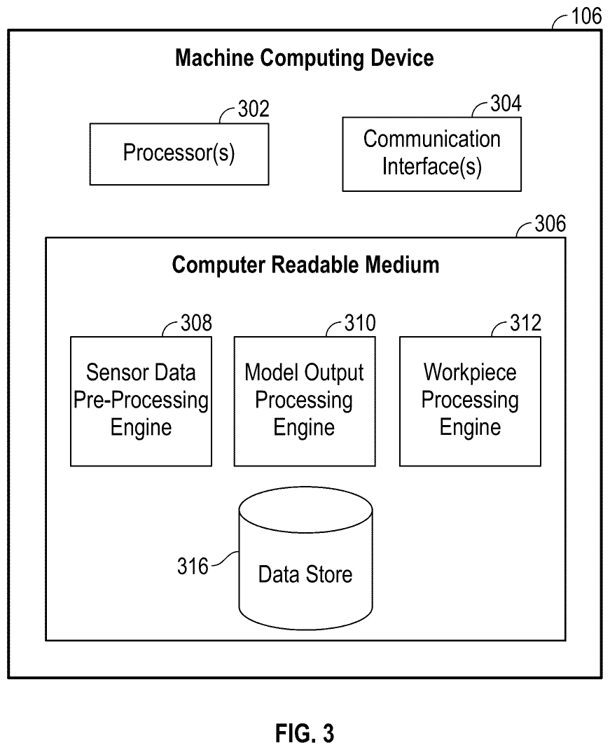

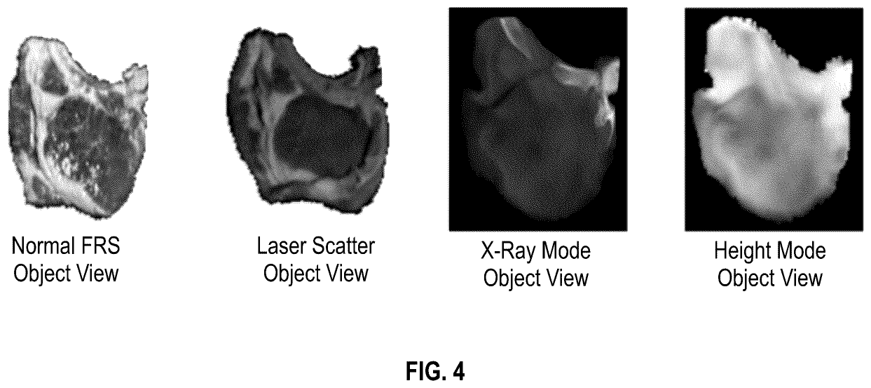

The results of the scanning occurring at sensor assembly 118 are transmitted to the machine computing device 106. The machine computing device 106 may include circuitry for executing one or more feature recognition modules in a sensor data pre-processing engine 308 (see FIG. 3) for generating views/images from the scan data and/or processing data from the different views. For instance, the sensor data pre-processing engine 308 of the machine computing device 106 may be configured to generate at least one of a fat recognition (FRS) object view, a laser scatter object view, and a height mode object view of a food product (see FIG. 4), such as from data captured with the optical scanner 121.

If separate conveyors are used for x-ray and optical scanning, the machine computing device 106 may first analyze the data from the X-ray apparatus 119 and the optical scanner 121 to confirm that the workpiece scanned by the optical scanner 121 is the same as the workpiece previously scanned by X-ray apparatus 119 and/or whether the workpiece has moved or shifted during transfer between conveyors. In that regard, a comparison of the X-ray and optical data may be processed by the sensor data pre-processing engine 308 of the machine computing device 106.

Such confirmation may be done, for instance, before the sensor data pre-processing engine 308 processes results of the optical scanning occurring at sensor assembly 118. Although any suitable method may be used for confirming that the workpiece scanned by the optical scanner 121 is the same as the workpiece previously scanned by X-ray apparatus 119, in some examples, the method used is substantially similar to that discussed in U.S. Pat. Nos. 10,654,185 and 10,721,947 (referenced above), incorporated by reference herein.

A second optical scanner, not shown, may be located upstream of the optical scanner 121 for use in capturing optical image(s)/data before the workpiece WP is transferred from a first (scanning) conveyor to a second (portioning) conveyor. The optical image(s)/data captured by the optical scanner 121 can be used to generate images for detecting the existence of certain visual characteristics, for confirming that the workpiece scanned the upstream optical scanner is the same as the workpiece previously scanned at optical scanner 121 and/or whether the workpiece has moved or shifted during transfer between conveyors, as discussed above. The second optical scanner may be located upstream or downstream of the sensor assembly 118. For instance, the second optical scanner may be used to scan the workpiece when located on a first conveyor, such as described in U.S. patent application Ser. No. 16/887,057, entitled “Determining the Thickness Profile of Work Products”, hereby incorporated by reference in its entirety.

In another example, an optical scanner may be located downstream of the optical scanner 121 for confirming that the workpiece scanned by the upstream optical scanner 121 is the same as the workpiece to be processed downstream of the optical scanner 121, such as after receiving output data from the data processing computing device 108. The scanners used in the systems and methods described herein exclude any type of scanning that could be done by human observation, which would not support the needed processing speed and accuracy of the food processing management system 102.

The cutting, portioning, trimming, etc., of a food product may be carried out by a workpiece machine processing engine 312 of the machine computing device 106 (see FIG. 3) or in a separate computing device in communication with the workpiece processing system 104. In that regard, the data processing computing device 108 and the workpiece utilization computing device 110 may send data relating to the food product being processed to the workpiece machine processing engine 312 so that the workpiece machine processing engine 312 may make any necessary adjustments for cutting or other processing of the food product within the required spec.

After any machine processing (e.g., cutting, portioning, trimming, etc.), the food product (and/or any material removed from the food product) may be transferred to a takeaway conveyor, a storage bin, the sorter 124, the packager 126, or other location, such as with a pick-up station 122. The pick-up station 122, sorter 124, and packager 126 may receive instructions from the machine computing device 106.

For example, if the food product is portioned into pieces, the machine computing device 106 may instruct the pick-up station 122 and/or the sorter 124 to remove or divert trim pieces or other unwanted pieces from the conveyor (based on, for instance, their known location on the conveyor resulting from the cutting instructions, data sent from the sensor assembly 118 and/or the data processing computing device 108 indicating that the incoming product was not the correct shape/size/type, to produce certain portions, etc.). In another example, the machine computing device 106 may instruct the pick-up station 122 and/or the sorter 124 to transfer all portions of a certain type to a designated conveyor, bin, etc., for packaging together.

Although FIGS. 1 and 2 depict specific components and sub-assemblies of a machine processing system, it should be appreciated that any other suitable arrangement of machine processing components may be used. For instance, the workpiece processing system 104 may incorporate aspects of the systems shown and described in U.S. Pat. No. 7,651,388, entitled “Portioning apparatus and method”, U.S. Pat. No. 7,672,752, entitled “Sorting workpieces to be portioned into various end products to optimally meet overall production goals”, and U.S. Pat. No. 8,688,267, entitled “Classifying workpieces to be portioned into various end products to optimally meet overall production goals”, hereby incorporated by reference herein in their entirety.

As noted above, workpiece processing management systems and methods disclosed herein include the implementation of a local, high power computing device (an “edge computing device”) that can receive input sensor data for a workpiece from a sensor associated with the processing machine, process the sensor data, and output requested workpiece data related to the input sensor data in a manner that enables more accurate or otherwise optimized machine processing of the workpiece. At the same time, the total computer processing time using the systems and methods disclosed herein is not only within the allotted total data processing time, but much lower in total data processing time compared to prior art methods.

In the examples depicted, the machine computing device 106 is configured to generate sensor data for a workpiece (and/or a machine feature) and output that sensor data (after any pre-processing) to the data processing computing device 108, which may represent the local, high power computing device or edge computing device referenced above. The data processing computing device 108 receives the sensor data from the machine computing device 106, processes the sensor data, and sends a corresponding output pertaining the workpiece back to the machine computing device 106. The machine computing device 106 processes the output received from the data processing computing device 108, and after any post-processing, the machine computing device 106 manages machine processing aspects of the workpiece. For instance, the machine computing device 106 may output instructions to one or more controllable components to optimize portioning, cutting, trimming, sorting, packaging, etc., of the workpiece based on information in the output.

It should be appreciated that in some examples, the machine computing device 106 and the data processing computing device 108 may be a single computing device. In other words, functional computing aspects of the machine computing device 106 and the data processing computing device 108 may instead be carried out by a single computing device. In that regard, in any of the examples described herein, functional aspects of computing devices may be carried out by any one of or combination of the computing devices described herein or any other computing devices.

However, it should also be appreciated that certain unique aspects of the systems and methods disclosed herein include generating sensor data with a machine computing device and sending that sensor data to a local, high power or edge computing device. In this manner, a heavy load of processing the sensor data and providing highly accurate and relevant output information for use in managing the workpiece machine processing can be easily achieved and managed by a separate computing device.

As will be described below, the data processing computing device 108 may be configured to store and execute machine learning models necessary for processing the sensor data. The machine learning models, as is typical, may require significant processing power and capacity. Moreover, as food processing needs change or as machine learning models are improved, it can be appreciated that the ability to easily access, update, and/or upgrade a separate computing device for use with the workpiece processing system 104 and optionally one or more additional processing systems in a facility would be beneficial. In that regard, it may be beneficial to configure aspects of the systems and methods described herein as including a data processing computing device 108 that is a local, high power or edge computing device separate from the machine computing device 106.

The data processing computing device 108 is described as being a local computing device. It should be appreciated that the term “local”, though illustrative of the desire for the data processing computing device 108 to be in close proximity to the machine computing device 106 to support high speed communications, minimal lag time, operator interactions, etc., it does not necessarily mean that the computing device is located on-site at the same facility, in the same operating space, in the same room, etc. Rather, as noted above, the data processing computing device 108 may be in close proximity to the machine computing device 106, whether in close physical proximity or digital proximity, to support high speed communications, minimal lag time, etc.

The data processing computing device 108 is also described as being a high power computing device. It should be appreciated that the term “high power” is illustrative of the desire for the data processing computing device 108 to have the computing capacity to support a heavy load of processing sensor data, such as with one or machine learning models, and outputting highly accurate and relevant data for use in processing or managing the processing of the workpiece. At the same time, the term “high power” does not necessarily mean that the data processing computing device 108 does not share computing powers with one or more other devices, that the data processing computing device 108 has a specific arrangement or configuration of hardware, etc.

Rather, as noted above, certain unique aspects of the systems and methods disclosed herein include generating sensor data with a machine computing device and sending that sensor data to a local, high power or edge computing device such that the heavy load of processing the sensor data and providing highly accurate and relevant output information can be achieved and easily managed.

Exemplary aspects of the machine computing device 106 will now be described with reference to FIG. 3. As noted above, the machine computing device 106 may be generally configured for generating sensor data for a workpiece (and/or a machine feature) and outputting that sensor data (after any pre-processing) to the data processing computing device 108. The machine computing device 106 is also configured to process output received from the data processing computing device 108, and after any necessary post-processing, the machine computing device 106 can use that output data to manage machine processing aspects of the workpiece.

In the exemplary block diagram of FIG. 3, the machine computing device 106 includes a processor(s) 302, a communication interface(s) 304, computer readable medium 306, and at least one data store 316. As shown, the computer readable medium 306 has stored thereon logic that, in response to execution by the one or more processor(s) 302, cause the machine computing device 106 to provide the sensor data pre-processing engine 308, the model output processing engine 310, and a workpiece machine processing engine 312.

The machine computing device 106 may be implemented by any computing device or collection of computing devices, including but not limited to a desktop computing device, a laptop computing device, a mobile computing device, a server computing device, a computing device of a cloud computing system, and/or combinations thereof. In some examples, the processor(s) 302 may include any suitable type of general-purpose computer processor. In some examples, the processor(s) 302 may include one or more special-purpose computer processors or AI accelerators optimized for specific computing tasks, including but not limited to graphical processing units (GPUs), vision processing units (VPTs), and tensor processing units (TPUs).

In some examples, the communication interface(s) 304 includes one or more hardware and or software interfaces suitable for providing communication links between components. The communication interface(s) 304 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As used herein, “engine” refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

As noted above, the sensor data pre-processing engine 308 of the machine computing device 106 may be configured to generate sensor data for a workpiece (and/or a machine component(s)) and send that sensor data (after any pre-processing) to the data processing computing device 108. The sensor data may include one or more images captured by the sensor assembly 118. For instance, the sensor data may include one or more images generated by the x-ray apparatus 119 and the optical scanner 121. The sensor data may also or instead include one or more measurements of the workpiece(s) and/or a machine component(s). For instance, the sensor data may include measurements of workpieces and/or conveyor belt components generated by a high-speed optical micrometer, as discussed herein.

The sensor data pre-processing engine 308 may perform any necessary pre-processing before sending the sensor data to the data processing computing device 108. Pre-processing may include generating views from image data, formatting image data and/or views generated from image data, packaging/condensing/transposing data for transmitting to the data processing computing device 108, etc. For instance, one or more of the imaging and/or calibrating methods described in U.S. Pat. Nos. 8,839,949, 10,471,619, 10,654,185, 10,721,947, 11,475,977, 10,427,882, 10,869,489, 11,266,156, incorporated by reference in their entirety, may be used for pre-processing.

In some examples, the sensor data pre-processing engine 308 may include one or more feature recognition modules for generating views/images from scan data. For instance, referring to the generated images shown in FIG. 4, the sensor data pre-processing engine 308 may be configured to generate at least one of a fat recognition (FRS) object view of a workpiece, a laser scatter object view of a workpiece, and a height mode object view of a workpiece, such as from data captured with the optical scanner 121.

The sensor data pre-processing engine 308 may be configured to generate a registered scan of a workpiece including a first scan of a first scan type (e.g., x-ray) and a second scan of a second scan type (e.g., an optical image). For instance, a registered scan of the workpiece may be generated by the sensor data pre-processing engine 308, which maps an X-ray image of the workpiece scanned at the x-ray apparatus 119 onto a (possibly transformed) optical image of the workpiece as scanned by optical scanner 121. In one example, the registered scan is generated by the sensor data pre-processing engine 308 using the systems and methods described in U.S. Pat. No. 10,654,185, incorporated herein by reference in its entirety. For instance, the X-ray data may be mapped onto the optical data, optionally with a transformation or translation of one or more of the images/data to account for any movement/shifting of the workpiece on a conveyor.

The sensor data pre-processing engine 308 may instead or additionally be configured to generate an image of a workpiece having multiple channels or layers. For instance, the sensor data pre-processing engine 308 may combine image files into a file(s) with one or more corresponding channels or layers. For instance, an Xray image, an FRS image, and a height map image may be combined into a single file with three channels. By combining images into a single file having multiple channels, all the necessary image data can be sent to the data processing computing device 108 in a single file rather than in separate files. As such, the data processing computing device 108 can process the file at optimal speeds and with higher accuracy.

In some examples, the sensor data pre-processing engine 308 may include one or more formatting modules configured to format the sensor data for optimal transport to and/or processing by the data processing computing device 108. For instance, formatting modules of the sensor data pre-processing engine 308 may perform at least one of transforming the sensor data, re-sizing the sensor data, labeling the sensor data, augmenting the sensor data, etc. In the specific example of an image, formatting modules may perform at least one of gray-scaling the image, translating the image, rotating the image, scaling/re-sizing the image, adjusting contrast of the image, changing the contrast of the image data, adapting the image to certain model constraints, etc. Any suitable image processing libraries (e.g., Python imaging processing libraries) available to the machine computing device 106 and/or the data processing computing device 108 may be used to carry out pre-processing of image data.

In one example, image sensor data may be labeled or tagged with information pertaining to the workpiece (“workpiece type”) or the process associated with the workpiece (“workpiece process”). For instance, information pertaining to the workpiece, or workpiece type, may include workpiece source (e.g., supplier, geographic region of origin, etc.), workpiece orientation (e.g., head v. tail first, membrane side up or down, etc.), workpiece maturity level (e.g., age, whether the fish was spawning, rigor mortis, etc.), etc. Information pertaining to the process associated with the workpiece, or workpiece process, may include workpiece process type (e.g., portioning, trimming, slicing, etc.), image sensor settings (e.g., scan slice rate), belt speed at which the image data was captured, belt type, environment (e.g., brightness level, background type, etc.), etc. In some examples, image sensor data may be labeled or tagged with information input by an operator of the processing machine, such as via an HMI input, before, during, and/or after a process is started. For instance, the operator may select from a list of possible labels or tags associated with a workpiece type and/or a workpiece process.

Pre-processing of the sensor data, such as image data and measurement data, may be done before the sensor data is, for instance, saved to the data store 316 and/or sent to the data processing computing device 108.

The sensor data pre-processing engine 308 may also be used to generate sensor data for a workpiece (and/or a machine feature) and output that sensor data (after any pre-processing) to the model management computing device 112 or a computing device (e.g., a cloud-based computing device) in communication with the model management computing device 112. The sensor data may be used to train the one or more machine learning models executable by the data processing computing device 108. In that regard, the same or substantially similar pre-processing may be done for any data used for both training and using the machine learning models for optimal consistency, reliability, and speed.

In that regard, labeled image sensor data may be used as training data for machine learning models that are used for processing workpieces of the labeled workpiece type (e.g., workpiece source, workpiece orientation, workpiece maturity level, etc.) and/or the workpiece process (e.g., workpiece process type, image sensor settings, belt speed at which the image data was captured, belt type, environment, etc.). For instance, image data that has a label indicating a workpiece type and/or a workpiece process will be used to train a machine learning model used for outputting information relevant for machine processing the workpiece type and/or using the workpiece process. In that manner, when a workpiece type and/or workpiece machine process is identified during data processing, the machine learning model specifically trained using training data labeled as that workpiece type and/or workpiece machine process may be executed by the data processing computing device 108 to output data for processing the workpiece type and/or using the workpiece machine process.

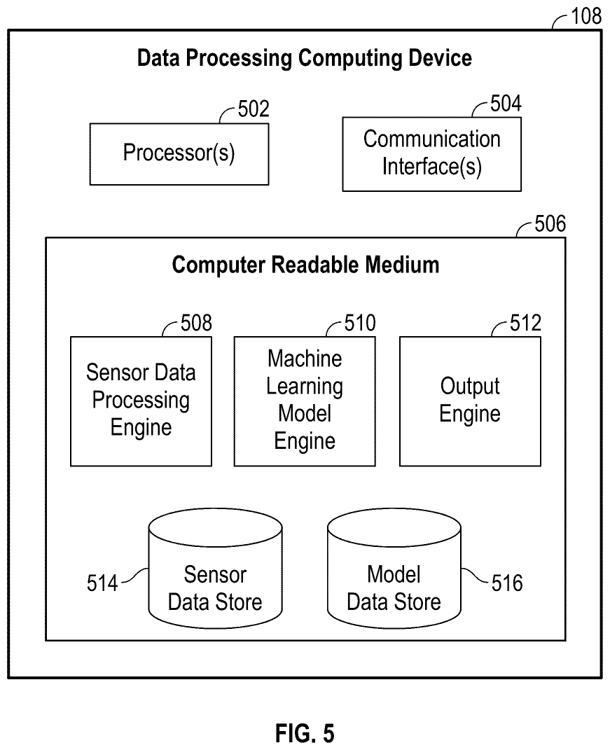

Referring to FIG. 5, aspects of the data processing computing device 108 will now be described in further detail. In the exemplary block diagram of FIG. 5, the data processing computing device 108 includes a processor(s) 502, a communication interface(s) 504, computer readable medium 506, and at least one data store, such as a sensor data store 514 and a model data store 516. As shown, the computer readable medium 506 has stored thereon logic that, in response to execution by the one or more processor(s) 502, cause the data processing computing device 108 to provide a sensor data processing engine 508, a machine learning model engine 510, and an output engine 512.

As noted above, the data processing computing device 108 may be a local, high bandwidth computer such as an edge computing device. The data processing computing device 108 may be implemented by a single computing device or collection of computing devices (e.g., a laptop computing device, a desktop computing device, a tablet computing device, a smartphone computing device, etc.) and may use any suitable processor(s) and communication interface(s), such as discussed above with respect to the machine computing device 106.

In one example, the data processing computing device 108 may be configured as a NVIDIA Jetson Orin package, such as an Advantech MIC-711-OX. A TCP/IP connection may be used to transfer data between the data processing computing device 108 and the machine computing device 106.

In some examples, data speed between the machine computing device 106 and the data processing computing device 108 may be increased by using PCI firewire or other communication bridges. In other examples, data speed between the machine computing device 106 and the data processing computing device 108 may be increased by continuing to use a general network protocol connection like TCP/IP, but while increasing the processing power of the data processing computing device 108.

The data processing computing device 108 may be generally configured to receive sensor data for a workpiece (and/or a machine feature) from the machine computing device 106 (and optionally store that data in the sensor data store 514) and process that sensor data. Processing the sensor data may include executing one or more machine learning models (stored in the model data store 516) trained to generate an output based on information provided in the sensor data. The machine learning model output may be sent back to the machine computing device 106, which can use that output data to manage machine processing aspects of the workpiece.

In some examples, the data processing computing device 108 may execute one or more machine learning models that output information to the machine computing device 106 including information realized by the machine learning model based on an image(s) in the sensor data. For instance, the data processing computing device 108 may output information regarding a location of a workpiece feature (e.g., bones, sciatic nerve, cut lines, outline, fat or lean area), an outline of the workpiece and any features therein (e.g., bones, fat/lean, foreign objects, etc.), a region of interest of the workpiece (e.g., an area comprising a maximum nominal height of the workpiece), a classification of the workpiece (e.g., sirloin pork chop, center loin pork chop, etc.), a location of a conveyor belt component relative to a coordinate system, etc.

The sensor data of the machine computing device 106 (and specifically, the sensor data pre-processing engine 308) is received by or otherwise retrieved by the sensor data processing engine 508 of the data processing computing device 108. A communication protocol may be used to reliably and efficiently send data between the machine computing device 106 and the data processing computing device 108 (such as between the sensor data pre-processing engine 308 and the sensor data processing engine 508).

The communication protocol may be configured as a high-level protocol that is not platform dependent and allows for simple commands to be used. For instance, the communication protocol may enable two-way communication between the machine computing device 106 and the data processing computing device 108. Protocol Buffers (Protobufs) may be utilized to optimize efficiency of data transport. The protocol may support both synchronous and asynchronous communications.

In some examples, a high level, restricted API implemented on the machine computing device 106 may be used to verify that the sensor data pre-processing engine 308 of the machine computing device 106 is sending the correct sensor data to the sensor data processing engine 508 of the data processing computing device 108. The API may further be configured to verify that the correct output data is being sent by the output engine 512 of the data processing computing device 108 to the model output processing engine 310 of the machine computing device 106.

For instance, each machine learning model may be identified by a unique identifier, such as a serial number, code, or the like. The unique identifier may be used in the communication data containing sensor data for calling a machine learning model(s) corresponding to an active software module in the machine computing device 106 (such as in the sensor data pre-processing engine 308 and/or the workpiece machine processing engine 312). Along the same lines, the unique identifier (or an identifier corresponding thereto), may be used in the communication data containing the machine learning model outputs (such as from the output engine 512 of the data processing computing device 108) for corresponding receipt by the model output processing engine 310 of the machine computing device 106.

After receiving sensor data from the sensor data pre-processing engine 308 of the machine computing device 106, the sensor data processing engine 508 of the data processing computing device 108 may perform any pre-processing of the sensor data needed for use in the machine learning models. In some examples, some or all pre-processing of the sensor data, as described above, occurs on the sensor data processing engine 508 in addition to or instead of on the sensor data pre-processing engine 308 of the machine computing device 106. The pre-processed sensor data may be stored in the sensor data store 514 for retrieval by the machine learning model engine 510.

In some examples, pre-processing of the sensor data may include correlating a tag or label of image sensor data (e.g., a workpiece type and/or workpiece process for a workpiece in an image) to a machine learning model specifically trained for that workpiece type and/or workpiece machine process. In that manner, the appropriate machine learning model may be called and executed by the data processing computing device 108 to output data for processing the workpiece type and/or using the workpiece machine process.

As a specific example, image sensor training data may be tagged with belt speed at which the training image was captured. Likewise, image sensor machine learning model input data or a “model input image” (e.g., an image of a workpiece to be analyzed by a machine learning model) may be tagged with belt speed at which the model input image was captured. It can be appreciated that image data parameters can vary, such as in size (e.g., pixel count), format (e.g., .png, jpeg, etc.), etc. Thus. pre-processing of the model input image may include correlating the tag indicating belt speed at which the model input image was captured to an identifier of the machine learning model (e.g., based on tags in the training data) that was trained using image sensor training data captured at the same belt speed. With the parameters of the training data of a machine learning model substantially matching the parameters of the model input data, the accuracy and reliability of machine learning model output can be optimized.

After performing any necessary pre-processing of the incoming sensor data, the machine learning model engine 510 may execute one or more machine learning models to process the sensor data and provide an output regarding information in the sensor data. Depending on a tag or label of the sensor data, which software application(s) is active within the data processing computing device 108 (such as within the workpiece machine processing engine 312), etc., the corresponding machine learning model(s) will be called and executed in the machine learning model engine 510.

Exemplary machine learning models configured to be carried out by the machine learning model engine 510 will now be described. It should be appreciated that the machine learning models are exemplary only, and other variations of the models described and/or additional models may also be used.

In one example, a classification machine learning model may be configured to classify a type of workpiece, such as a type of sub-primal cut. As described in U.S. patent application Ser. No. 18/462,776, hereby incorporated by reference in its entirety, processing sub-primal cuts may vary depending on the type of sub-primal cut. For instance, certain types of sub-primal cuts may be portioned or trimmed in accordance with customer specifications or other requirements specific to that cut type. Moreover, certain types of sub-primal cuts may be used in certain end products depending on, for instance, supply and demand of the types of sub-primal cuts.

Classification machine learning models of the machine learning model engine 510 may be configured to identify sub-primal cuts and categorize the sub-primal cut into one of at least two categories, such as for value sorting and/or value optimizing of the sub-primal cuts. For instance, a classification machine learning model(s) of the machine learning model engine 510 may be configured to identify sub-primal cuts or “chops” of a full bone-in pork loin, such as those shown and described in U.S. patent application Ser. No. 18/462,776, incorporated herein.

A classification machine learning model(s) for identification/categorization of sub-primal cuts (e.g., “chops” of a full bone-in pork loin) into one of at least two categories may be configured to provide at least one classification probability score for a sub-primal cut based on a scan image(s) of a sub-primal cut. For instance, the sensor data pre-processing engine 308 of the machine computing device 106 may send an X-ray and/or optical image of a pork chop to the sensor data processing engine 508 of the data processing computing device 108. Based on information in the pork chop image(s), the classification machine learning model(s) may output a classification probability score (percent likely) for one of a number of different pork chop types.

An example may be described in reference to Table 1 shown below. The possible classification types may include “sirloin center chop”, “sirloin pinbone”, “center cut loin chop”, “center rib chop”, and “rib end chop”. Based on information in the pork chop image(s), the classification machine learning model(s) may provide an output including the probability score for at least one of the types of chops, the classification of the chop based on the highest probability, or some combination thereof. For instance, the model output may simply include a label of “sirloin center chop”, seeing as the model determined that a “sirloin center chop” is the most probable classification for the pork chop. Such an output may be sent to the model output processing engine 310 of the machine computing device 106 for use in processing the pork chop.

In other instances, the classification model output may include the probability score for each of the possible types of chops. For instance, the model output may include all the probability scores shown below. With such a model output, the model output processing engine 310 of the machine computing device 106 may determine how to process the pork chop. For instance, referring to the example shown below, the model output processing engine 310 may classify the pork chop as a “sirloin center chop” because it has a probability score of more than 30%.

In other instances, the model output processing engine 310 may classify the pork chop as something other than the chop with the highest probability if data received from the finished workpiece supply/demand engine 130 of the workpiece utilization computing device 110, for instance, indicates that a higher demand exists for a different type of chop. For instance, referring to the example shown below, the model output processing engine 310 may classify the pork chop as a “center rib chop” if the probability score is within a certain acceptable range (e.g., greater than 25%) and demand for the “center rib chop” exceeds demand for the “sirloin center chop”.

TABLE 1

| Pork Chop Type | Probability Score (%) |
|---|---|
| Sirloin Center Chop | 31.0 |
| Sirloin Pinbone | 11.2 |
| Center Cut Loin Chop | 5.7 |
| Center Rib Chop | 28.5 |
| Rib End Chop | 23.6 |

In some examples, the classifications in the output of a classification machine learning model(s) may be adjusted to accommodate different specification requirements for the workpiece. For instance, a first food processor or customer may categorize a pork chop as a type 1 sirloin chop (e.g., having a high grade/value), whereas a second food processor or customer may categorize the pork chop as a type 3 sirloin chop (e.g., having a lower grade/value). In such cases, the output of the classification machine learning model(s) may be adjusted to meet the end specifications.

At least one of the model output processing engine 310 and the output engine 512 may perform post-processing on the classification output to shift the classification of the workpiece into the more appropriate classification, category or type. As an example, if a pork chop is classified as a type 1 sirloin chop by the model because it had a classification probability score above a certain minimum value, such as 30%, the model output processing engine 310 and the output engine 512 may re-assign the pork chop to a type 3 sirloin chop because the classification probability score is between 30-50%.

Classification machine learning models of the machine learning model engine 510 may be configured to identify workpieces as portions of a primal or sub-primal cut. For instance, referring to FIG. 6, classification machine learning models of the machine learning model engine 510 may be configured to identify portions of a poultry butterfly, such as right or left “singles” of a poultry butterfly (or right and left portions). For instance, a classification machine learning model may use an image of one of a poultry butterfly, a poultry left single, and a poultry right single as input to output a workpiece classification (e.g., poultry butterfly, poultry left single, or poultry right single) and/or a classification probability score as output. Such classification machine learning models configured to identify workpieces as portions of a primal or sub-primal cut may be trained using images of left and right portions “flipped” to create synthetic right and left portion images, respectively (e.g., left portions can be flipped to create right portion images and right portions can be flipped to create left portion images). In some examples, both greyscale and height map training and input images are used. In some examples, only greyscale training and input images are used. Moreover, the inventors have found, through experimentation, that a high performing architecture for such a poultry classification machine learning model is a convolutional neural network, and specifically, the Pytorch ResNet-18 architecture, which reached higher than 99% classification accuracy.

In some situations, image sensor data for a workpiece in a first orientation differs from image sensor data for the workpiece in a second, flipped orientation. For instance, “shadowing” can occur if a single camera is used. More specifically, in some situations, the light stripe may be momentarily blocked from view of the single camera by a section of the workpiece that extends upward above the surrounding portions of the work piece. In a specific example of a fish fillet, shadowing often occurs behind the head end of the fillet when running the fillet tail first. Moreover, chicken breasts, especially when very fresh, can have undercutting from the edge in, or at the very front towards the back.

As discussed above, the video camera detects the displacement of the shadow line/light stripe from the position it would occupy if no food product were present on the conveyor belt. This displacement, which may be used to generate a height map, represents the thickness of the food product along the shadow line/light stripe. The determined thickness, along with a given value for the density of the workpiece being analyzed, is used to calculate the weight of the workpiece. Workpiece weight is used in various aspects of workpiece machine processing control, and thus, accuracy is important. A discussion of this aspect of workpiece machine processing is included in U.S. Pat. No. 11,570,998B2, entitled “Determining the thickness profile of work products,” the entire disclosure of which is incorporated by reference herein.

To account for the difference in calculated weight based on workpiece orientation (e.g., head first v. tail first, etc.), processors typically designate the workpiece orientation for loading (often done manually), and the operator sets/adjusts a density setting on a workpiece machine processing machine corresponding to the designated orientation. For instance, a first density value may be used for a first workpiece orientation (e.g., head first), and a second density value may be used for a second workpiece orientation (e.g., tail first). However, if the workpiece is loaded incorrectly, processing of that workpiece will be suboptimal because it will be based on an inaccurate weight. Moreover, having to load all the workpieces in the same orientation is time consuming, labor intensive, and prone to error.

Classification machine learning models of the machine learning model engine 510 may be configured to identify orientation of workpieces (e.g., head v. tail first, membrane side up or down, etc.) such that the density value or a similar parameter may be automatically adjusted for accurate workpiece machine processing. For example, a classification machine learning model may use an image of a workpiece with the workpiece in one of various orientations as input to output a workpiece (e.g., head v. tail first, membrane side up or down, etc.) and/or a classification probability score as output. The workpiece orientation and/or the classification probability score may be processed by the workpiece machine processing engine 312 of the machine computing device 106 to designate a corresponding density value, a corresponding correction factor to the existing density value, etc., in a manner well known in the art.

Such classification machine learning models configured to identify orientation of workpieces may be trained using images of workpieces in a first orientation “flipped” to create synthetic images showing the opposite orientation (e.g., images showing a workpiece moving downstream on a conveyor head first can be flipped to create images showing a workpiece moving downstream on a conveyor tail first, and vice versa). In some examples, both greyscale and height map training and input images are used. In some examples, only greyscale training and input images are used. Moreover, similar to classification machine learning models configured to identify workpieces as portions of a primal or sub-primal cut, the classification machine learning models configured to identify orientation of workpieces may be configured with high performing convolutional neural network architecture, and specifically, the Pytorch ResNet-18 architecture.

A classification machine learning model may be trained with image data of the workpiece of interest, wherein each image may be labeled with one or more classification types. Such annotated image data may be sent to the model management computing device 112 for training the classification machine learning model. The classification machine learning model learns to provide classification probability scores based on the features recognized in the images compared to the training data.

The output of a classification machine learning model may be sent to the workpiece machine processing engine 312 of the machine computing device 106 for carrying out and/or changing one or more aspects of workpiece machine processing. For instance, the workpiece machine processing engine 312 may instruct at least one of the slicer 116, cutter station 120, pick-up station 122, and sorter 124 to slice, cut, move, and/or divert the workpiece corresponding to the output based on the classification of the workpiece. As a specific example, the workpiece machine processing engine 312 may instruct the pick-up station 122 and/or sorter 124 to package together workpieces of a first type of classification based on a demand received from the workpiece utilization computing device 110.

In other examples, an image segmentation machine learning model of the machine learning model engine 510 may be configured to identify features of a workpiece, identify separate workpieces on a conveyance system 115, etc., by segmenting or “cutting out” an object(s), feature(s), etc., in an image as output. The image segmentation machine learning model may incorporate the Segment Anything Model (SAM) available from Meta AI, FastSAM from Ultralytics, or another suitable image segmentation model using image segmentation techniques.

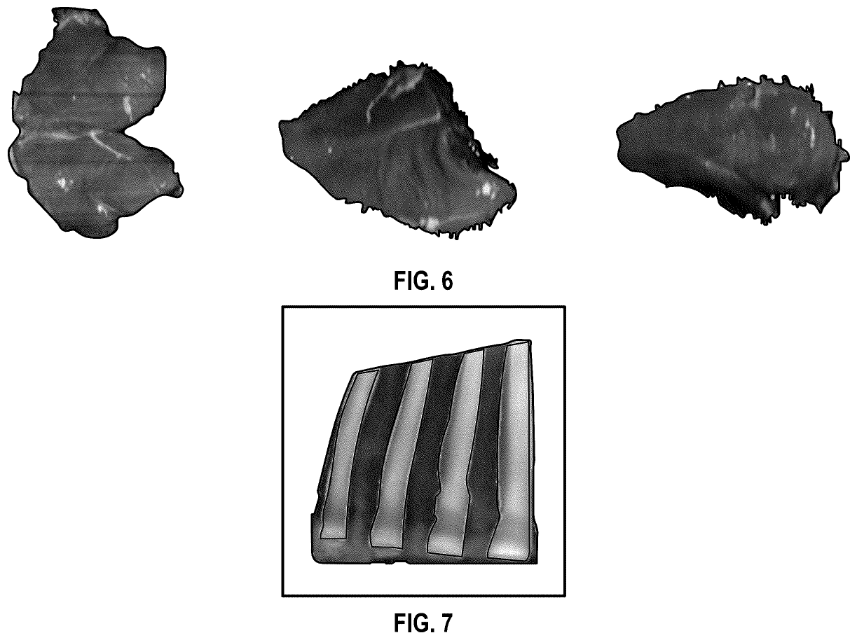

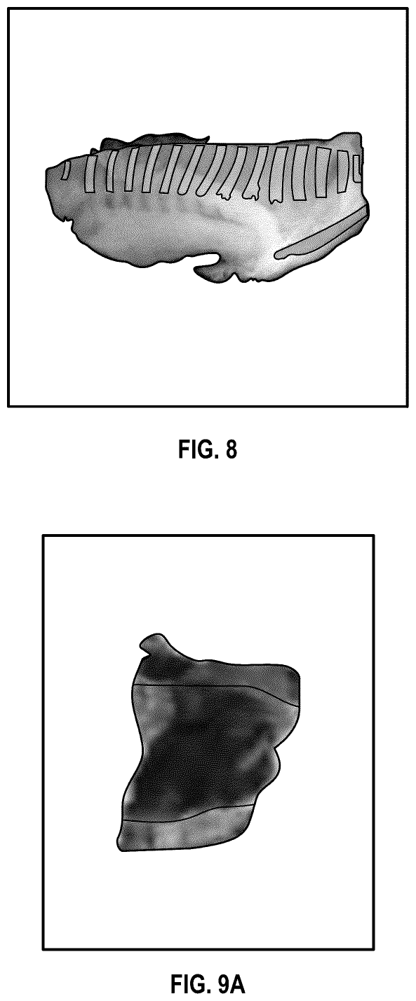

An image segmentation machine learning model may use images sent from the sensor data pre-processing engine 308 to identify features of a workpiece. For instance, a workpiece feature image segmentation machine learning model may provide an outline of bones as output based on an X-ray image sent from the sensor data pre-processing engine 308 as input. The output may be a binary image or a map showing the location of the bones, with every pixel indicating the presence or absence of bone. In such an instance, only a single channel image, such as an x-ray image, may be needed as input, saving processing time and capacity. For instance, an image segmentation machine learning model may be trained to identify/outline bones of a workpiece (and optionally an overall outline of a workpiece). A binary output image of the model (optionally after any post processing) may include the input image of the workpiece with an outline of the bones (e.g., a beef rib) and an overall outline of the workpiece (e.g., a rack of beef ribs), as shown in FIG. 7. In another example, a multi-class output image of the model (optionally after any post processing) may include the input image of the workpiece with an outline of various types of bones (e.g., rib and brisket bones in a rack of pork spare ribs), as shown in FIG. 8.

The output images can be used by the machine computing device 106 to define cut lines for the workpiece around one or more of the bones. With accurate data regarding bone location, the workpiece can be trimmed, cut, etc., more closely to the bone, minimizing product waste or yield loss.

Further, bone location may also be used by the model output processing engine 310 to classify workpieces. Such bone location data may be used alone or in combination with classification probability scores, as discussed above.

A fat/lean boundary image segmentation machine learning model may also be used to identify fat/lean boundaries in various workpieces. For instance, the fat/lean boundary image segmentation machine learning model may provide an image having an outline of fat and/or lean areas in a workpiece as output based on an optical image(s) sent from the sensor data pre-processing engine 308 as input. The model output may be, for instance, a marked-up version of the input image with computer-generated annotations showing outlines of the fat and/or lean areas in a workpiece.

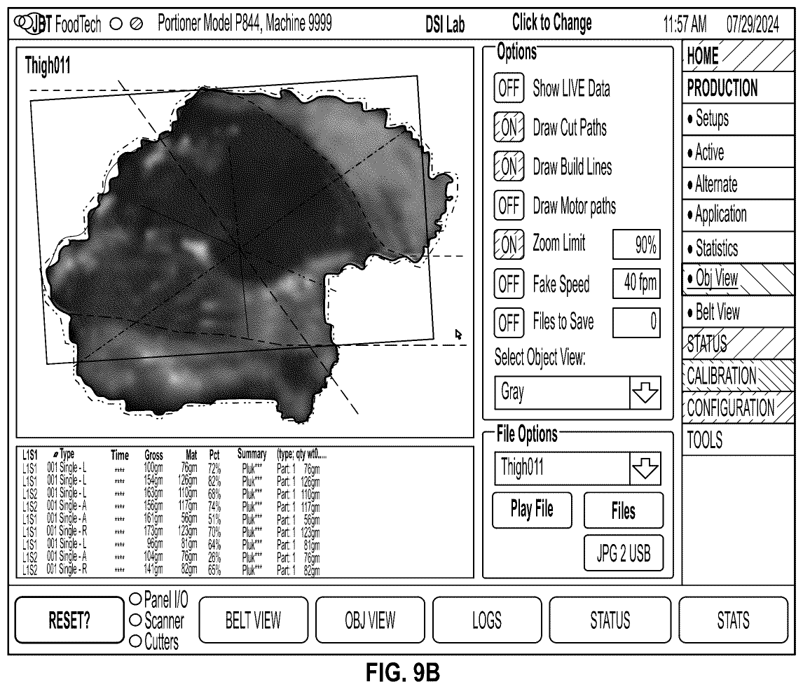

In one example, a fat/lean boundary image segmentation machine learning model may be configured to identify fat caps at a top and bottom of a poultry thigh, such as a chicken thigh. For instance, a fat/lean boundary image segmentation machine learning model may be trained to identify/outline a mid-section or lean meat section of a chicken thigh between top and bottom fat caps of the thigh. Referring to FIG. 9A, a binary output image of the model (optionally after any post processing) may include the input image of the chicken thigh with an outline of the mid-section and the overall outline of the chicken thigh. Segmentation in this manner was found to be more effective than outlining the fat caps themselves. In any event, the binary output image can be used by the machine computing device 106 to define cut lines for the chicken thigh to trim or cut off the fat caps.

The cut lines, which may be defined using the output of the fat/lean boundary image segmentation machine learning model, may be optimized to maximize the excised fat and/or the remaining lean meat section. Optimization of the cut lines may be done by supplying supplemental training data to the model management computing device 112. In some examples, the supplemental training data may include annotated images showing substantially optimal cut lines.

Referring to FIG. 9B, substantially optimal cut lines may be defined in an annotated image of a chicken thigh by first identifying/defining substantially a center point of the lean meat section and generating one or more axes extending through the center toward a perimeter of the chicken thigh. The axes may be used to define a location/size of a minimum bounding rectangle or similar around the lean meat section. Intersection points may be defined between the minimum bounding rectangle (MBR) and the pixels defining generally four corners of the lean meat section. The intersection points can be adjusted to optimize the cut lines, such as by rotating the MBR around the center point of the lean meat section. Such image data processing may be carried out on a suitable computing device using suitable software programs known in the art.

A fat/lean boundary image segmentation machine learning model trained to identify/outline a mid-section or lean meat section of a chicken thigh between top and bottom fat caps of the thigh, as described above, can isolate the mid-section even when the mid-section includes fat portions. By comparison, when using feature recognition software to process greyscale images, such as a fat recognition (FRS) object view (showing fat streaks within the product), any fatty portions/streaks in the mid-section can cause processing delays and feature segmentation output errors. Thus, by using a fat/lean boundary image segmentation machine learning model trained to identify/outline a mid-section or lean meat section of a chicken thigh as described herein, data processing speed and quality can be increased.

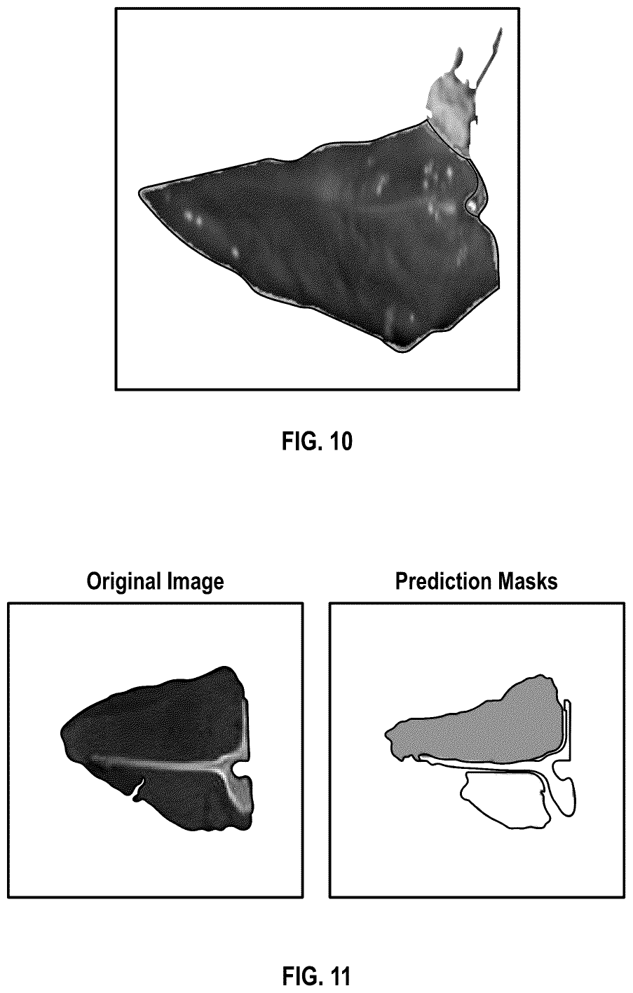

In one example, a fat/lean boundary image segmentation machine learning model may be configured to identify extraneous fat and/or stringy pieces of a poultry piece, such as a chicken breast. For instance, referring to FIG. 10, a fat/lean boundary image segmentation machine learning model may be trained to identify/outline a meat section of a chicken breast, excluding the extraneous fat and/or stringy pieces. The fat/lean boundary image segmentation machine learning model may be configured to identify extraneous fat and/or stringy pieces of a poultry piece by a difference in grayscale darkness, its location near a perimeter of a workpiece, etc., which becomes evident when training the model with annotated image data identifying/outlining a meat section of a chicken breast.

A binary output image of the model (optionally after any post processing) may include the input image of the chicken breast with an outline of substantially only the meat section of the chicken breast. The binary output image can be used by the machine computing device 106 to define cut lines for the chicken breast to trim or cut off the extraneous fat pieces, to exclude the extraneous fat pieces from an estimated size of the workpiece (e.g., a weight or volume), etc.

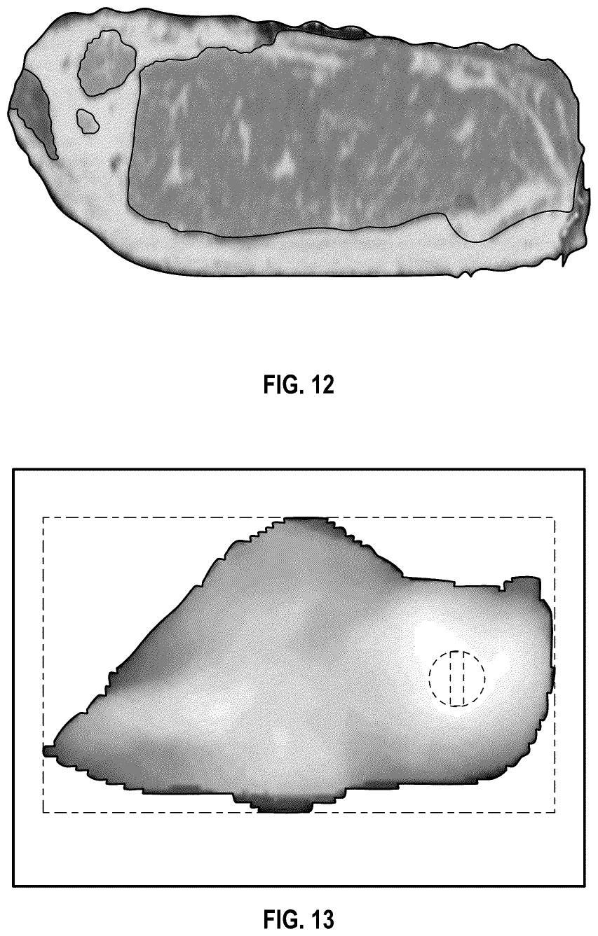

In some examples, the output of an image segmentation machine learning model may be non-binary or multi-class. Such a non-binary output may be useful when the image segmentation machine learning model is used to identify three or more regions or features in a workpiece image. A multi-class image segmentation machine learning model may be executed to identify various portions in a workpiece, such as bones and lean/fat regions in a steak. For instance, referring to FIG. 11, an image segmentation machine learning model may be executed to identify/outline bone, tenderloin, and strip for a T-bone steak in an output image (the prediction mask on the right) based on an input image of the T-bone steak (e.g., the X-ray image on the left). Referring to FIG. 12, an image segmentation machine learning model may be executed to identify/outline lean eye, false eye, false lean, and the outer boundary of a steak in an output image based on an input image of the steak (e.g., a grayscale image).

A workpiece isolation image segmentation machine learning model may also be used to isolate a workpiece on a metal belt. As noted above, workpieces are typically portioned with a waterjet on an open mesh, metal belt. However, imaging of a workpiece, such as x-ray imaging, is typically done with the workpiece on a solid fabric or plastic belt to ensure the outline integrity of the workpiece. Thus, the workpiece must be transferred from a solid belt to an open metal belt for processing, which can cause disruption to the workpiece machine processing (e.g., shifting of a workpiece). Using a workpiece isolation image segmentation machine learning model in accordance with examples herein, the workpiece may be scanned and processed on an open metal belt because the workpiece can be identified as an object in the image separate from the metal belt and outlined accordingly.

Such a workpiece image segmentation machine learning model may also be useful in calculating a thickness/height of a product (such as a chicken breast) while accounting for any sag, wear, gaps, etc., in the belt. Metal belts used for waterjet cutting can wear unevenly and allow the bottom of the workpiece resting on the belt to “sag” and follow the contours of the belt. In other words, if a conveyor belt is not continuous and flat, the workpieces may “sag” into the gap a small amount. When belts wear unevenly or sag, any part of the product sitting on the sagged or worn portion of the belt is typically unaccounted for during processing.

Current methods used to account for belt variations include calibrating a scanner field of view to ignore portions of a belt that may cause data inconsistencies. Specifically, portions of a belt are removed from a scanner field of view with a calibration procedure that establishes a z-axis zero line at a height just above the top of the belt, as described in U.S. Pat. No. 10,427,882B2, incorporated by reference herein in its entirety. Any objects below the zero line, including the belt and any part of the product sitting on the sagged or worn portion of the belt below the zero line, are ignored during processing.

By using a workpiece image segmentation machine learning model to isolate the workpiece from the belt in accordance with the description herein, the “zero line” can be effectively established below the belt. As a result, a product resting on worn or sagging areas of the belt can be included in the field of view and accurately measured. In other words, a bottom surface of the workpiece may be outlined or otherwise isolated from the belt top surface to accurately measure the total thickness/height of the workpiece. In that regard, the workpiece image segmentation machine learning model can be used for calculating a thickness/height of a product while accounting for any sag, wear, gaps, etc., in the belt.

A workpiece image segmentation machine learning model described herein, as well as other techniques described herein for assessing belt issues, may be used to improve upon known methods of accounting for an uneven bottom surface of a work product (e.g., voids), such as those described in U.S. Pat. No. 11,570,998B2, incorporated by reference herein. The method described in U.S. Pat. No. 11,570,998B2 can be used to account for an uneven bottom surface of a product in calculating height or weight/mass of a workpiece. However, such methods do not account for an uneven belt surface. Thus, the method described in U.S. Pat. No. 11,570,998B2 may be improved by using a workpiece image segmentation machine learning model described herein to account for belt height differences.

A workpiece image segmentation machine learning model may also be useful in removing a keel strip from chicken or pin bones from fish if removed over a gap between adjacent metal belts, as discussed above. To most accurately remove the keel strip/pin bones, the chicken or fish product that sags below the top of the belt must be accounted for. A workpiece image segmentation machine learning model can be used to accurately measure product that sags below the top of the belt, similar to when it drops into worn or sagging portions of a belt. Note that a height profile of a bottom surface of the workpiece that sags into the gap between the belts may be determined in a number of ways, such as using conveyor belt data for a known location of the workpiece on the belt, as discussed below.

In some examples, one or more image segmentation and/or workpiece classification machine learning models may be used to identify aspects of a conveyor system, e.g., the conveyance system 115. For instance, machine learning model(s) may be used to identify a segment (e.g., one or more belt links) within an endless conveyor belt having a known sag, belt wear, stretch, or other issues or information, and such issues or information can be accounted for in workpiece machine processing. In the example of belt sag, if a portion of a workpiece is located on a belt segment having a known sag, the height measurement of the workpiece can be correspondingly adjusted for workpiece machine processing.

An image segmentation machine learning model may be executed to isolate a portion of a conveyor belt so that specific aspects of that portion of the belt may be analyzed. For instance, an image segmentation machine learning model may output an outline of at least a portion of a belt link(s) of a belt, on which a workpiece rests for processing, based on one or more images of the at least a portion of the belt link(s) as input. The outline of the belt link(s) in the output data may show any sag, stretch, wear spots, etc. of the belt link(s).

Using the outline data as input, a workpiece classification machine learning model may be executed to identify the portion of the conveyor belt as output. For instance, the outline showing the sag, wear, etc., in the belt link(s) can be used to identify a portion or location of a conveyor belt based on reference data for that portion or location.

Information such as sag, belt wear, or other data for each portion or location of a belt may be determined using any suitable method. For instance, a 3D model of the conveyance system 115 may be generated from images of the conveyance system, CAD images of components of the conveyance system, and/or measured values of components of the conveyance system. In some examples, a 3D model of one segment of a belt is used to create a 3D model of an entire endless conveyor belt, and then the 3D model is modified or tagged with data regarding information for each portion or location of the belt. A 3D model of the conveyor belt (optionally with other aspects of the conveyance system 115), may be useful as a “map” of the entire belt. For instance, the known sag, wear, etc., can be accounted for in workpiece machine processing, as noted above.

Further, comparisons between the identified portion in the machine learning model output and the reference data (e.g., 3D model) may also be used to monitor and attend to belt health or other aspects of the conveyance system 115. In that regard, the belt may be monitored over time for assessing wear, stretch, sag, etc. In some examples, the outline output data of an image segmentation machine learning model may be continuously or periodically compared to the reference belt information (e.g., a 3D model) to determine if the sag, wear, stretch, etc., has changed. In that regard, measurements of belt components, taken or determined from the image segmentation machine learning model outline output data, may be compared to the reference data of the conveyance system 115. Comparisons may be made using standard data processing techniques executed on a computing device, such as on the model output processing engine 310 or workpiece machine processing engine 312 of the machine computing device 106.

If a height of a belt component has decreased compared to the reference data, if a distance between belt pickets or rods is measured to be more than a distance in the reference data, etc., corrective actions may be taken. In some examples, the reference data, such as a 3D model of the belt, may be revised. In that manner, the revised sag, wear, etc., can be accounted for in workpiece machine processing, as noted above. In some examples, the workpiece machine processing engine 312 of the machine computing device 106 may adjust processing plans to account for change in the conveyor belt.

Reference to a 3D model of the conveyance system 115 may be used, for instance, in place of an encoder for determining the position of a workpiece on the conveyor belt as well as the progress or movement of the food workpiece in the conveyance direction. In some examples, reference to a 3D model of the conveyance system 115 can be used to determine workpiece transition between powered conveyor belts or information regarding conveyor belt gaps.

In some examples, a workpiece image segmentation machine learning model output that outlines/identifies workpiece features may be used to generate a 3D model of the workpiece including such outlined/identified workpiece features. The workpiece image segmentation machine learning model(s) may be executed using images of first and second (e.g., top and bottom, front and back, etc.) opposing surfaces of a workpiece as input. The output may include an outline and/or an identification of workpiece features in the images of the top and bottom of the workpiece, such as using the systems and methods described herein. Based on a correlation of those features, a 3D model of the workpiece can be generated showing or otherwise including the features that extend at least partially through the height of the workpiece, such as bones, cartilage, fat, etc.

Images of the top and bottom of a workpiece may be captured or generated in any suitable manner. For instance, the optical scanner 121 may generate images (e.g., greyscale, height, etc.) of both top and bottom surfaces of a workpiece (e.g., a pork chop) by utilizing a prior cut piece top image as a mirror image of the target workpiece bottom image (e.g., sliced chops of a pork loin). In other instances, the sensor assembly 118 may include a scanner beneath the conveyance system 115 for capturing an image of a workpiece bottom. In yet other instances, the workpiece may be flipped over (such as at a separate station or by the pick-up station 122) such that a top and bottom image of the workpiece may be captured. In other instances, a bottom image of a workpiece may be generated by projecting a top surface of an optical height map down to the bottom surface (and vice versa) using a mass from an X-ray image and an assumed density, such as that described in U.S. Pat. No. 11,570,998B2, entitled “Determining the thickness profile of work products,” incorporated herein. In any event, an image matching process, such as that described above, may be carried out to match or correlate the images to a workpiece.

A 3D model of the workpiece showing/including workpiece features that are outlined/identified in a workpiece image segmentation machine learning model output may be generated (such as by the model output processing engine 310 of the machine computing device 106) in any suitable manner. For instance, in an initial step, X-Y coordinates may be assigned to outlines or other location-identifying aspects of the identified features. In one step, equal quantities of X-Y coordinates or points for each of the features on the top and bottom of the workpiece can be created, with equal spacing between the points. Such a step(s) may be carried out using a computing device (e.g., the sensor data pre-processing engine 308 and/or the model output processing engine 310 of the machine computing device 106) and computing techniques well known in the art.

As a next step, the top and bottom outlines of the workpiece in the images may be aligned using a computing device (e.g., the sensor data pre-processing engine 308 and/or the model output processing engine 310 of the machine computing device 106) and computing techniques well known in the art. In some examples, the techniques may include using the workpiece outlines, as defined on vertical edges of the workpiece, to align the image datasets. For instance, the workpiece outlines may be aligned using the techniques described in U.S. Pat. No. 10,654,185, entitled “Cutting/portioning using combined X-ray and optical scanning”, as well as U.S. Pat. No. 10,721,947, entitled “Apparatus for acquiring and analysing product-specific data for products of the food processing industry as well as a system comprising such an apparatus and a method for processing products of the food processing industry,” incorporated herein by reference in their entirety.

As a next step, the X-Y coordinates of the location-identifying aspects of the identified features (e.g., the feature outlines) can be transformed, shifted, etc., to accommodate or otherwise match the alignment of the outlines of the workpiece in the images. The X-Y coordinates can be transformed, shifted, etc. using a computing device (e.g., the sensor data pre-processing engine 308 and/or the model output processing engine 310 of the machine computing device 106) and computing techniques well known in the art. For instance, techniques described in U.S. Pat. Nos. 10,654,185 and 10,721,947, incorporated herein, may be used.

As a next step, a computing device (e.g., the sensor data pre-processing engine 308 and/or the model output processing engine 310 of the machine computing device 106) can execute one or more algorithms, programs, etc. to extrapolate identified features from images of both surfaces through the height of the workpiece, such as defined by height map image data. In that regard, a next step may essentially include computationally drawing a series of (optionally straight) lines, arcs, etc. between corresponding X-Y coordinates of the features in the images of the top and bottom of the workpiece. The lines or other connecting methods can define aspects of the features that are internal to the workpiece, or between the top and bottom surfaces of the workpiece. Such a step may be carried out using a computing device (e.g., the sensor data pre-processing engine 308 and/or the model output processing engine 310 of the machine computing device 106) and computing techniques well known in the art.

In some examples, the 3D model may be generated by the model output processing engine 310 using height map data of the workpiece and one of the top and bottom images of the workpiece. The 3D model may then be augmented to define the interior aspects of the features by correlating the other of the top and bottom images of the workpiece to the 3D model.

In some examples, the 3D model may be generated by extrapolating density data from the top surface down to the bottom surface to estimate the shape of the bottom surface including any voids, such as using techniques described in U.S. Pat. No. 11,570,998B2, hereby incorporated by reference in its entirety.

In some examples, the 3D model may be used to define additional predicted surfaces of the workpiece at one or more Z coordinates of the workpiece. For instance, a 3D model of a workpiece having top and bottom surfaces may be bisected substantially horizontally to define the predicted bottom and top surfaces of first and second half portions of the workpiece. Such predicted substantially horizontal workpiece surfaces of the first and second half portions can be used to determine the value of such half portions knowing the predicted surface features. In that regard, a substantially horizontally workpiece surface may be defined at any or all of the Z coordinates of the 3D model, such as to define an optimal horizontal cutting plane. In some examples, a workpiece surface(s) may be defined at an angle to the top and bottom substantially horizontally surfaces of the workpiece using the 3D model. Such an angled workpiece surface(s) may be used to define an optimal angled cutting surface(s) for the workpiece.

The 3D model may be used for managing various aspects of workpiece machine processing. In some examples, the 3D model output may be used as input for a workpiece classification machine learning model to provide a classification probability score for each face (top and bottom) of the workpiece. In that regard, the overall or final classification of the workpiece assigned by the model output processing engine 310 may be based on the higher probability score of the two faces and/or supply or demand information from the workpiece utilization computing device 110. In related examples, the top or bottom of the workpiece may be selected for display in packaging based on the classification of that side of the workpiece (e.g., a higher value classification, such as per the workpiece utilization computing device 110, may be chosen for display in the packaging).

In some examples, the 3D model may be used by the workpiece machine processing engine 312 to plan and carry out cut paths of the workpiece. For instance, the model output processing engine 310 and/or the workpiece machine processing engine 312 of the machine computing device 106 may process the data contained in the 3D model to identify the locations of the features. In some examples, the 3D models can be used to define lean or meat portions of a workpiece in all areas that are not identified as the feature(s). In some examples, the 3D models may be used to define additional predicted surfaces of the workpiece at one or more Z coordinates of the workpiece, as discussed above.

The 3D model data can be used in a 2D and/or 3D cutting module of the workpiece machine processing engine 312 for cutting the workpiece (e.g., with the cutter station 120) according to certain specifications (e.g., fat removed, bones excised, no lean trim, combined fat areas, preferred workpiece surfaces, etc.). Cut paths for a workpiece may be defined by the workpiece machine processing engine 312 to follow the outlines of the features, to optimize workpiece machine processing to ensure the feature is fully excised, trimmed out, isolated to one of multiple portions defined by the cutting of the workpiece, etc. The 3D model data can also be used to determine how to cut the food product into desired portions and/or trim the food product into a desired overall shape.

In some examples, a 3D model can be used to define angled cut paths of waterjet cutters by the workpiece machine processing engine 312. Angled cut paths may be needed to precisely remove features of the workpiece. For instance, fat, bones, or other undesirable material may run through workpieces at an angle. An angled cut is often required to cut away that undesirable material, such as fat or bones, without cutting away valuable lean (meat) of the workpiece. In some instances, the 3D model can be used by the workpiece machine processing engine 312 to estimate the location of an angled feature inside the workpiece and generate an angled cut path for removing that feature, such as by analyzing one or more predicted angled workpiece surfaces (and optionally predicted horizontal workpiece surfaces) of the 3D model.

Angled cut paths may also be needed to optimize downstream processing steps of the workpiece. For instance, angled workpiece edges/faces can produce a workpiece having a higher surface area per weight, allowing for more breading pickup and/or improved appearance. The workpiece machine processing engine 312 may generate an angled cut path plan to define angled workpiece edges/faces based on the workpiece thickness/height, internal features, outline shape, classification, etc.

In some instances, a 3D model can be used to predict voids, undercutting, or other irregularities of the workpiece. In that regard, one or more workpiece anomaly programs may be executed to output a predicted workpiece shape, workpiece contour, or absence of substrate, including voids, undercutting, or other irregularities, based on an estimated workpiece weight and volume determined from the workpiece 3D model. Estimations of workpiece weight and volume may be done in accordance with the systems and techniques shown and described in U.S. patent Ser. No. 11/570,998B2, entitled “Determining the thickness profile of work products”, incorporated herein. In that regard, the one or more workpiece anomaly programs may be used to estimate workpiece weight and volume data of a workpiece correlated to observed or measured voids, undercutting, or other irregularities of the workpiece.

The workpiece anomaly program(s) may be executed by the workpiece machine processing engine 312 to adjust any aspects of workpiece machine processing. For instance, if a different workpiece machine processing plan (e.g., cut paths) would better accommodate the predicted workpiece shape, workpiece contour, or absence of substrate (e.g., voids, undercutting, or other irregularities), one or more parameters or settings of the processing system may be adjusted, such as its density setting, a slice thickness, a portion size, etc., to account for the anomaly(ies).

In other examples, a region of interest (ROI) machine learning model of the machine learning model engine 510 may be configured to generate an ROI as output based on an image(s) (e.g., x-ray and/or optical image(s)) sent from the sensor data pre-processing engine 308 as input. The ROI may be a proposed portion or outline of an area/object of a workpiece. The ROI may be represented as a binary mask image (e.g., in the mask image, pixels that belong to the ROI are set to 1 and pixels outside the ROI are set to 0) or in another format usable by the model output processing engine 310. The model output may further include symbolic (textual) labels added to the ROI, such as to describe its content in a compact manner, as well as individual points of interest (POI) within the ROI.

The ROI in the workpiece image may be used to locate a feature in the workpiece, it may be used to designate an area in the workpiece for a measurement (e.g., a height measurement, a temperature measurement, etc.), or some other purpose. In some examples, the ROI output of a ROI machine learning model is used to define an area on a workpiece likely defining a peak thickness/height of the workpiece. For instance, chicken breast fillets are not uniform in thickness/height across the width/length of the chicken breast. Rather, a peak thickness/height of the chicken breast is typically at a rounded end of the chicken breast, and the slimmer part of the breast is near a pointy end of the breast. If part of a chicken breast is thicker than the other, it will take longer for the thicker part to get to a safe temperature during a cooking process. As the thicker part reaches the safe temperature, the slimmer part will dry out. Accordingly, chicken breasts may be processed (e.g., portioned, trimmed, sorted, etc.) to account for the cooking temperature differences. To manage such processing, an accurate peak height measurement can be important.

An ROI machine learning model output indicating a peak height area of a chicken breast may include an area in a rounded end of the chicken breast (which is the thickest/tallest area of the breast) that is substantially level, such as in the exemplary output image shown in FIG. 13. By finding the flattest spot in a peak thickness region of the chicken breast, the ROI will likely exclude any ridges and meat protrusions. The ROI output may also include a POI indicating the precise peak height for the chicken breast. Using the ROI/POI output of the ROI machine learning model, the model output processing engine 310 may appropriately manage further processing of the chicken breast.

In some examples, the ROI output of a ROI machine learning model may define an area on a chicken breast for measuring height and/or slope of a caudal ridge of a chicken breast or butterfly to check for woody chicken. As is known in the industry, woody chicken, or chicken that has an unpleasant texture (e.g., hard to the touch, tougher, more complex consistency, coarse fiber texture, etc.) can often be recognized by a prominent caudal ridge. If an ROI is identified in an image of the chicken pertaining to a relevant caudal ridge area, the relevant height/slope of the caudal ridge can be determined for grading/assessing the chicken.

By assessing the chicken as it is being cut, the control system can optimize cutting each piece based on the severity of the defect, and then sort the cut pieces to appropriate uses. As an example, pieces with no detected woody chicken may be utilized for premium sandwich portions, while pieces with slight woodiness may be used for lesser valued thin sliced portions, and pieces with more extreme woodiness may be diverted to products often made from trim, such as pet foods or marinate solutions.

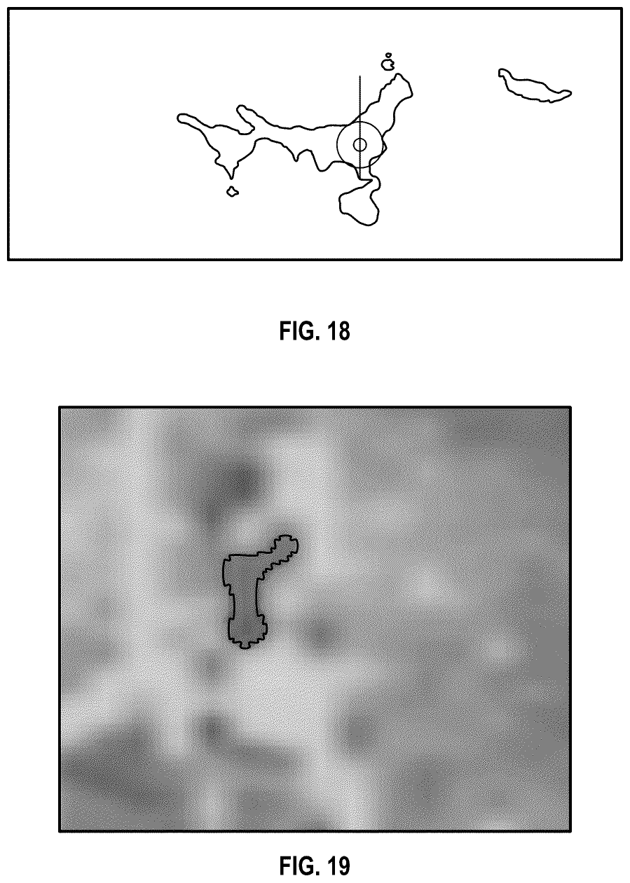

As noted above, the ROI output in the workpiece image may be used to locate a feature in the workpiece. In some examples, an ROI machine learning model may be executed to locate an ROI in a piece of steak likely containing a sciatic nerve. The sciatic nerve, which can be found in filet mignon or other cuts of steak, is typically located within a layer of fat in the steak. Moreover, the sciatic nerve is often located within a center of a substantially largest portion of a specific fatty region of the filet. In that regard, in some examples, the ROI output for a filet mignon piece may be defined by a substantially largest inscribing circle that can be superimposed onto the fatty region in the image, such as in the exemplary output image shown in FIG. 18.

A POI in the ROI may be at substantially the center of the ROI, locating the likely location of the sciatic nerve. The ROI/POI output may be sent to the model output processing engine 310 for managing processing of the filet mignon (e.g., portioning the filet mignon pieces into two or more pieces with only one piece containing the sciatic nerve, portioning the filet mignon pieces into two or more pieces while excising the sciatic nerve, removing the sciatic nerve, etc.)

An ROI machine learning model may be trained with image data identifying the region of interest, such as with annotations, labels, etc. The ROI machine learning model learns to identify the ROI based on the features recognized in the images compared to the training data and the location of the ROI/POI relative to those features. For instance, if a human operator is measuring chicken breasts at a QA station, the operator may indicate a peak height location in an image of the workpiece being measured (such as with a touch screen). For the sciatic nerve, an image of a piece of filet mignon may be annotated to include a substantially largest inscribing circle in the specific layer of fat containing the nerve. Such annotated image data may be sent to the model management computing device 112 for training the ROI machine learning model.

An ROI machine learning model may be configured as a semantic segmentation model. Semantic segmentation is generally understood as the attempt of a model to categorize each pixel in an image into a class. In the case of locating the sciatic nerve, there could be two classes, sciatic region or not. With only two classes, a positive (sciatic nerve) and negative class (background), the ROI machine learning model may be configured for binary segmentation. In the case of binary semantic segmentations, labeled data may include a black and white segmentation mask, where the white portion is the region of interest (e.g., the fatty region containing the sciatic nerve), and the black portion is the rest of the image.

EfficientNet (ENet), which is a segmentation model, was found to be a useful architecture for an ROI machine learning model in accordance with the systems and methods disclosed herein. ENet is understood to be a convolutional neural network (CNN) that uniformly scales the dimensions of the input images using a coefficient. ENet aims to have less parameters and work quicker than traditional segmentation models.

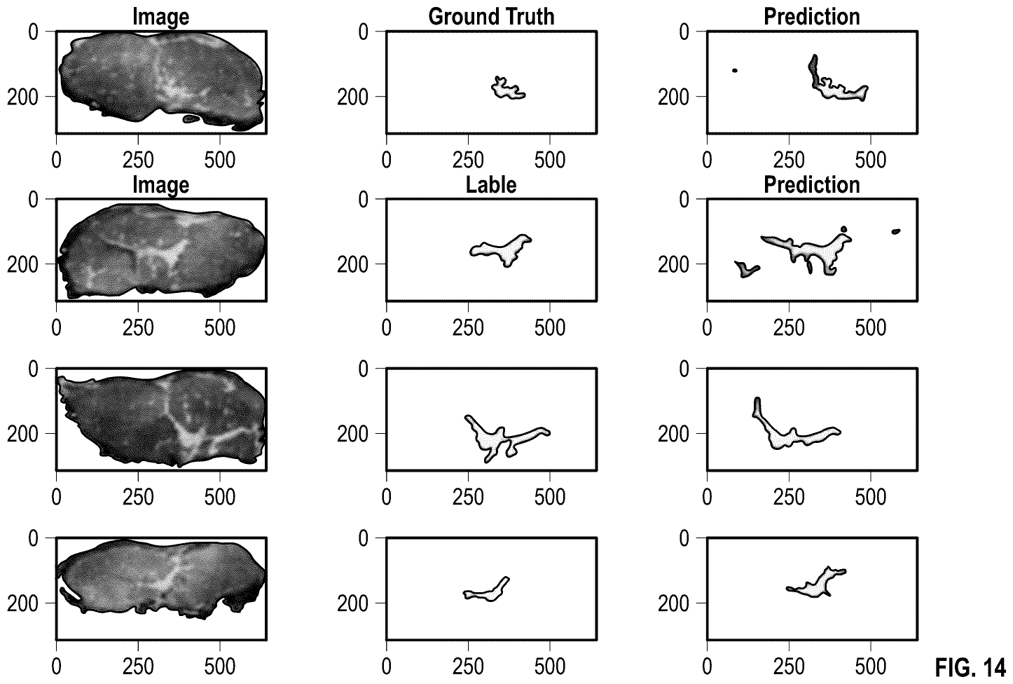

Before the inventors proceeded with significant data collection, labeling, and preprocessing to train an ROI machine learning model for sciatic nerve detection, ENet was verified as a viable option by reviewing results of the ENet model on a limited number of images. The output of the ENet model was an image that was the same dimensions as the input image with the predicted sciatic region. The preliminary results with limited data are set forth in FIG. 14. The preliminary results were enough to show that deep learning was a viable option for sciatic nerve detection, and the inventors proceeded with such a solution. In other words, because of the positive results, more data was collected and labeled for training the ROI machine learning model for sciatic nerve detection.

Generally, in computer vision projects, an increased number of training images increases the quality of the machine learning model. Often, computer vision projects need thousands of labeled training images in order to become stronger and more generalizable. However, pixel-by-pixel labeling of training images for sciatic nerve segmentation is incredibly labor intensive, and so it is impractical to hand-label an adequate number of training images to successfully train the model. In some embodiments, data augmentation techniques may be used to increase the number of usable training images from a smaller set of hand-labeled training images.

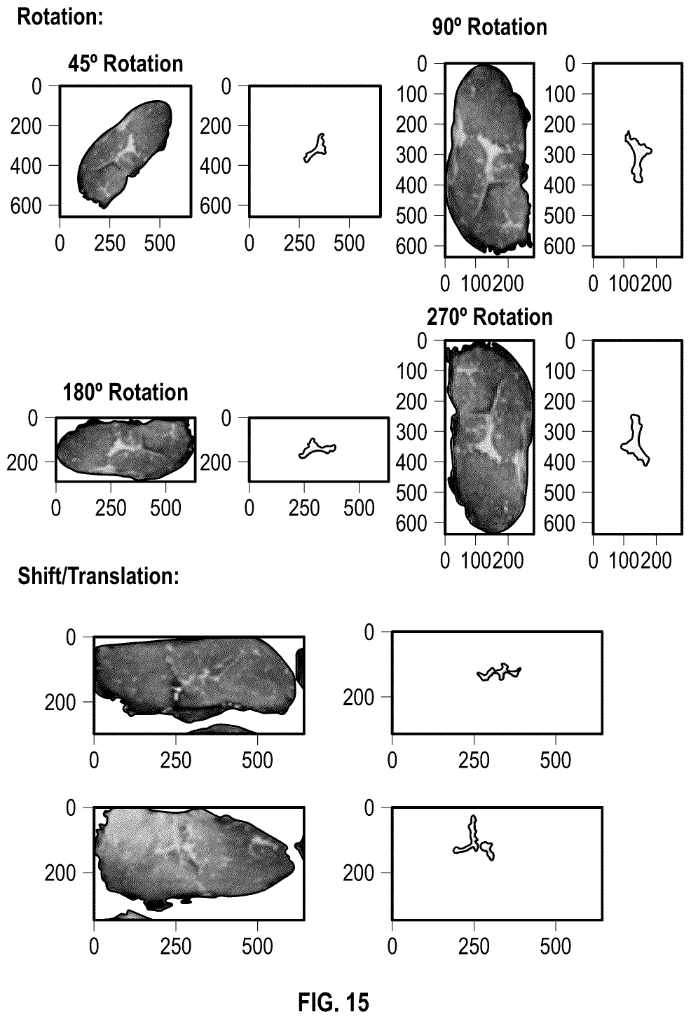

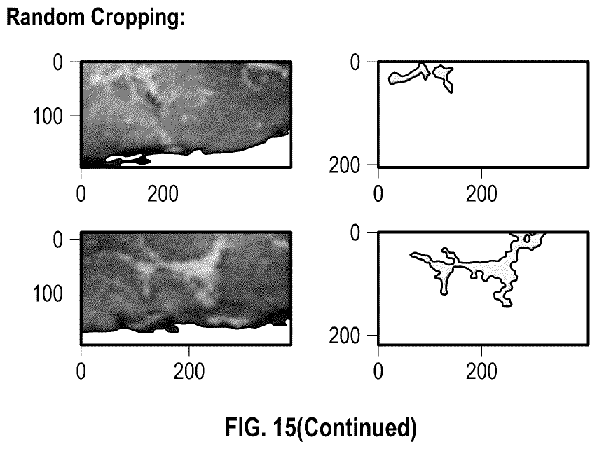

There are generally two main types of data augmentation techniques: geometric augmentations and color space augmentations. Geometric augmentations involve rotating images, translating images, zooming in on images, cropping images, shearing images, etc. Any geometric augmentations that are done to images typically also need to be done to the labels. Color space augmentations generally include contrast enhancement and brightening. Any color space augmentations that are done to images typically do not have to be done to labels. Many augmentations were tested for the ROI machine learning model for sciatic nerve detection, and the inventors determined that color space augmentations generally had a negative effect on model performance. Thus, only geometric augmentations were used. Examples of geometric augmentations of training images for the ROI machine learning model for sciatic nerve detection are shown in FIG. 15.

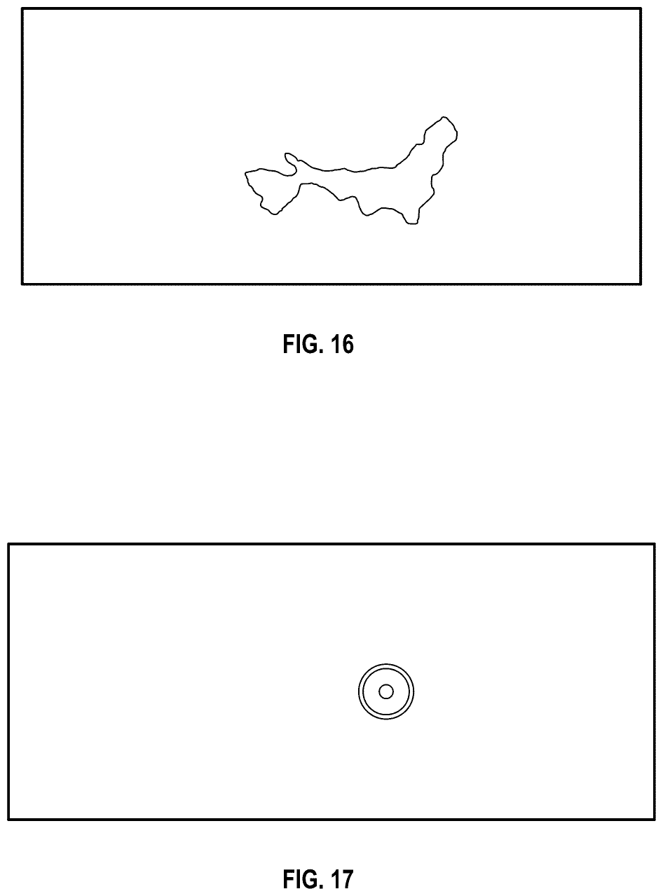

Referring to FIGS. 16-18, a post-processing algorithm for processing the ROI machine learning model output to predict the location of the sciatic nerve will now be described. In a first step, an algorithm may first locate a substantially largest contour in the predicted region of interest (e.g., the fatty region likely containing the sciatic nerve). For instance, the algorithm can be configured to find the substantially largest contour of the predicted region of interest and draw it onto a new mask (see FIG. 16). In a next step, the algorithm may be configured to define a substantially largest inscribing circle within that substantially largest contour, draw it onto a new mask, and then find the centroid of that substantially largest inscribing circle (see FIG. 17). In a next step, the algorithm may be configured to draw both the inscribing circle and the centroid on the original output image showing the predicted region of interest to predict the location of the sciatic nerve at the centroid (see FIG. 18). Optionally, as shown in FIG. 18, the algorithm may be configured to draw a line through the centroid to visualize/define an optimal cutline for the steak. The sciatic nerve is generally located near the center of the fatty region in the steak, so finding the substantially largest inscribing circle and its center can find the sciatic nerve.

After review of a preliminary training dataset for ROI machine learning model for sciatic nerve detection was labeled and critiqued by industry personnel, it was determined that the majority of the training images did not contain a sciatic region at all. In fact, the percentage of training images within the preliminary training dataset with no sciatic region was roughly 75%. Furthermore, in the training images that have a sciatic region, the sciatic region consumes only roughly 3% of the image. Therefore, the preliminary training dataset for the ROI machine learning model for sciatic nerve detection faced severe class imbalance. Using that preliminary training data set to train the ROI model would cause the model to learn to predict only black background, i.e. that no input images have sciatic regions. Such a prediction minimizes model loss because most of the image data is simply black background. Class imbalance can be handled using data science practices, including weighting the positive class which penalizes the model when it misses the positive class, in this case the sciatic region, more than the negative class, the black background. Class imbalance can also be handled by oversampling, which is when you generate more images with the positive class, or under sampling, which is when you remove images that do not contain the positive class. Weighing or oversampling the positive class may be done until the ROI machine learning model for sciatic nerve detection performed acceptably.

Other machine learning models may be executed by the machine learning model engine 510 using sensor data of a workpiece as input, such as to provide information regarding a carcass side of a workpiece, a skin side of a workpiece, a tenderloin notch location, etc.

Any suitable type of machine learning models may be executed, including but not limited to convolutional neural networks (CNNs) and fully convolutional networks (FCNs).

In the example of a classification machine learning model in accordance with the systems and methods disclosed herein, such as a model configured to identify sub-primal cuts and categorize a sub-primal cut into one of at least two categories (e.g., “chops” of a full bone-in pork loin, portions of a poultry butterfly, etc.), classification may be achieved through a supervised learning approach. A convolutional neural network (CNN) architecture may be employed, which, through a hierarchy of learnable filters, extracts increasingly complex features from the input images to differentiate between various sub-primal cuts.

After considerable experimentation with various architectures, the inventors have found that the ResNet-18 architecture from PyTorch™ is the most successful machine learning model for use in workpiece classification machine learning models configured in accordance with the systems and methods disclosed herein. This model has proven effective in binary and multi-class classification tasks, delivering high accuracy in the classification of different workpieces.

Over time, through a process known as backpropagation, the classification machine learning model may be configured to fine-tune its internal parameters to minimize the classification error. Post-training, the classification machine learning model can categorize new unseen workpiece (e.g., sub-primal cut) images into one of predefined cut classes with high accuracy. A dataset comprising images of various workpieces (e.g., sub-primal cuts), including various surfaces of the workpieces, each labeled with its respective workpiece type, may be used to train the classification machine learning model.

In the example of an image segmentation machine learning model to identify features of a workpiece, such as bones, fat, lean, etc., feature identification may be achieved utilizing fully convolutional networks (FCNs). For instance, an image segmentation machine learning model formed in accordance with the systems and methods disclosed herein (e.g., the workpiece feature image segmentation machine learning model, the fat/lean boundary image segmentation machine learning model, the workpiece isolation image segmentation machine learning model, the ROI machine learning model) may be trained to recognize and map locations of features (e.g., bones) within a workpiece. By training a machine learning model with a vast dataset of labeled images where the feature regions are marked (e.g., pixel-wise labeled images), the model learns to identify features/areas in new, unseen images. The images for training data may be labeled by outlining the features with computer-aided tools (e.g., ImageJ using a fit spline function).

Some image segmentation models can be used without training (e.g., machine learning model may incorporate the Segment Anything Model (SAM) available from Meta AI, FastSAM from Ultralytics, or another suitable image segmentation model using image segmentation techniques). However, in some examples, the reliability and efficiency of the image segmentation machine learning model may be optimized by supplying training data to the model management computing device 112. For instance, annotated images showing outlines of features, cut lines, etc., may be used to further train the image segmentation machine learning model.

If multiple features in different classes need to be identified (e.g., bones and lean of a workpiece), the training images may include multiple binary labels corresponding to each of the features/regions (e.g., rather than creating a multiclass label for each training image). To manage the complexity of transforming binary masks for each feature/region into a format usable by an image segmentation machine learning model, a “mask combiner” engine (or an “ImageMaskCombiner” engine) may be used.

An “ImageMaskCombiner” engine is designed to manage the combination of binary masks of different regions of interest from product images, like bones and lean of a workpiece. Such an engine loads and processes individual masks, assigns distinct values to each region, and merges them into a “combined mask” for machine learning tasks. Additionally, the engine generates visual overlays by highlighting regions of interest in the original image and calculates class weights based on region frequency, aiding in model training. The “ImageMaskCombiner” engine automates this workflow for efficient processing and validation of multiple images.

For example, a training image of a T-bone steak may include a label for the bone, the tenderloin, and the strip. An “ImageMaskCombiner” engine may then be used to format the labeled training image into a format usable by an image segmentation machine learning model. In that manner, an image segmentation machine learning model formed in accordance herein can be used for segmentation of multiple regions within a single input image. The model output may include a marked-up version of the input image (e.g., an X-ray, grayscale image, or a multi-channel image combining image sources) showing an outline of the feature(s).

Unlike regular CNNs, FCNs are structured to output spatial maps, making them suitable for tasks like semantic segmentation where precise localization of features (e.g., bones) is crucial. A UNet architecture, which is a style of FCN, may be customized for analyzing sub-primal cut images to identify certain features, attributes, etc. For instance, a UNet architecture may be customized for analyzing pork chop images to identify bone regions.

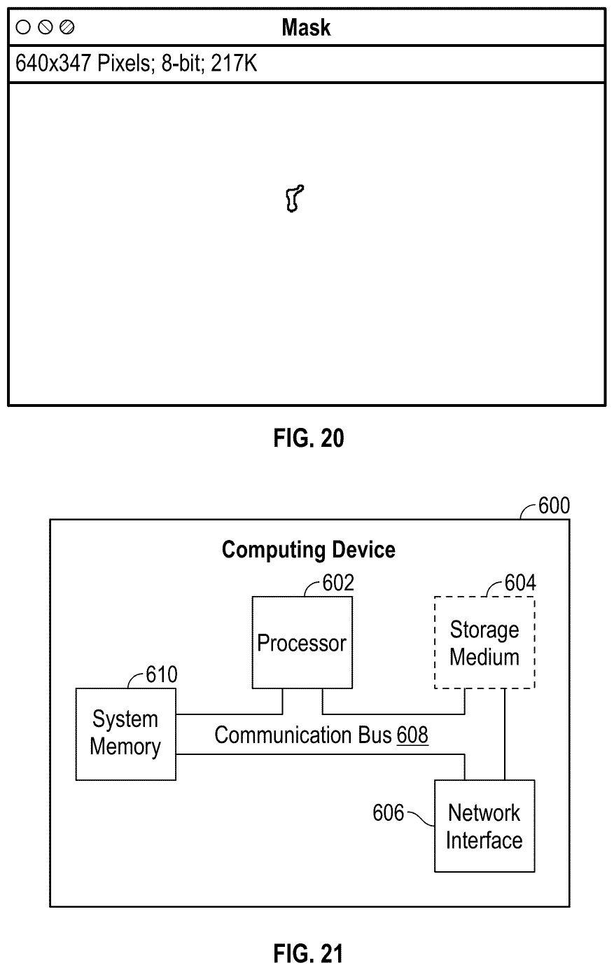

In the example of an ROI machine learning model to identify an ROI of a workpiece, such as a peak height, a fatty region containing a sciatic nerve, etc., ROI identification may be achieved utilizing semantic segmentation models, as noted above. Training an ROI machine learning model formed in accordance with the systems and methods disclosed herein may include labeling training images of the workpiece to identify the ROI. For instance, in the example of identifying a sciatic nerve ROI of a steak, a training image of a steak may be labeled using suitable computer-aided tools, such as ImageJ. In a specific example, after opening an image file in ImageJ, changing the image from RBG to greyscale (e.g., to 8-bit), and zooming in on the relevant area of the steak in the image, a tracing tool or the like (set with an appropriate tolerance depending on the size of the sciatic nerve) may be used to define an outline for the ROI, as shown in FIG. 19. For instance, using the tracing tool, a trainer can select or click on the sciatic nerve, and an outline should appear around it. The trainer can then create a mask for the outlined structure, as shown in FIG. 20. The mask can be saved as the label for the training image. Industry experts can verify the labels before using the labeled images for training the ROI machine learning model.

Images used to train and run the machine learning models described herein are generally consistent in size/format. More specifically, the inventors found that execution of the machine learning models is optimized using a substantially identical input image format that was used for training the model. However, standard image processing libraries like Open-CV has the capabilities to change/adjust all training and/or model input images as needed. The inventors found that using a fixed 256×256 pixel format works well for training input images.

Data augmentation may be used to artificially enlarge a dataset by applying various image transformations, like rotation or flipping, thereby enhancing model robustness and mitigating overfitting in deep learning vision tasks, as discussed above.

An augmentation approach that closely mirrors realistic variations observed in workpieces on a production line may be used. Such augmentation may include subtle rotations, translations, and adjustments to brightness and contrast. If there is consistent orientation of workpieces as they move within the workpiece processing system 104, extreme alterations (e.g., flips or 90-degree rotations) may be avoided, as they may detract from the model's training relevance.

During training, the machine learning model can also be configured to adjust its weights to minimize the error in feature detection or classification. The weights of the machine learning models can be fine-tuned and customized based on the specific dataset used for training. Tailored weighting helps to ensure that the machine learning model is uniquely attuned to the nuances of workpiece images, increasing precision and specificity in the model outputs. Various additional techniques, such as data augmentation, transfer learning, and optimization algorithms may also be employed to enhance the performance of the machine learning model and help ensure accurate feature detection or classification.

The deep learning workflow that can be used for training one or more of the machine learning models disclosed herein can begin with data collection and preprocessing to organize the data into a usable format. The data may then be split into training, validation, and test sets to ensure a robust training regimen and evaluation of the machine learning model. The machine learning models may be trained for many epochs, or passes through the training data, optionally using GPU acceleration to expedite the training process. Once trained, the machine learning models may be evaluated on unseen data to assess their performance, followed by fine-tuning or re-training as necessary. This iterative process may continue until satisfactory accuracy and efficiency are achieved, after which the machine learning models may be deployed on a suitable computing device, such as the data processing computing device 108, in the production environment for real-time processing of workpieces.

Any other suitable technique may be used to train the machine learning models, including but not limited to one or more of gradient descent, hyperparameter tuning, and freezing/unfreezing of model architecture layers. In some examples, annotated, raw images are used as the training input. In some examples, one or more features derived from the images, including but not limited to versions of the images in a transformed color space, set of edges detected in the image, one or more statistical calculations regarding the overall content of the images, or other features derived from the images may be used instead of or in addition to the annotated raw images to train the machine learning models.

The data processing computing device 108 (e.g., the machine learning model engine 510 and/or the output engine 512) is configured to concurrently manage multiple machine learning model tasks, such as workpiece classification and feature identification. By integrating multiple machine learning model tasks, the computational workflow of the data processing computing device 108 is maximized (enhancing the operational efficiency of the data processing computing device 108 and the workpiece processing system 104), and a synergy is created between the different tasks. Accuracy can also increase, as data insights gleaned from one task can inform and refine another task.

The inventors have found that using the machine leaning model architectures described herein supports an increase in workpiece image data processing accuracy without comprising workpiece image data processing speed, such as in comparison to using standard image processing techniques that are carried out on the machine computing device 106. The workpiece image data processing speed using the machine leaning model architectures described herein, when carried out on an edge computing device separate from the machine computing device 106, is within the allotted time to support necessary workpiece machine processing speeds of the workpiece processing system 104. In other words, sending workpiece image data to a separate edge computing device (e.g., the data processing computing device 108) and processing that workpiece image data by running one or more of the machine learning models described herein does not compromise workpiece image data processing speed.

Referring back to FIG. 3, the model output processing engine 310 is configured to receive machine learning model output data from the output engine 512 of the data processing computing device 108. The model output processing engine 310 may perform any necessary post-processing of the outputs.

For instance, the model output processing engine 310 may include one or more formatting modules configured to perform, for instance, any of the pre-processing steps noted above or any other steps necessary for using the outputs in managing processing of the workpiece (e.g., matching the formatting of the output data to the original sensor data, formatting the output data for compatibility with one or more modules of the model output processing engine 310, etc.). In one example, formatting modules may be configured to convert pixel locations associated with aspects of an output image to a coordinate system of the workpiece machine processing engine 312.

The model output processing engine 310 may also include one or more modules configured to select one or more outputs of a plurality of outputs generated by the machine learning models. For instance, if the machine learning model outputs three possible classification labels for a type of sub-primal cut (e.g., pork chops), each with varying degrees of probability, the model output processing engine 310 may categorize the workpiece as a certain type based on information sent from the raw workpiece supply/demand engine 128 and/or the finished workpiece supply/demand engine 130 of the workpiece utilization computing device 110.

For instance, if the raw workpiece supply/demand engine 128 sends information to the model output processing engine 310 indicating that the supply of workpieces, e.g., pork chops, is likely to contain more of a certain type, then a workpiece that may be classified as one of multiple types (per product specifications) may be classified as the type of chop that is in lower supply. In the alternative or in addition thereto, if the finished workpiece supply/demand engine 130 sends information to the model output processing engine 310 indicating that the demand of certain workpieces, e.g., sirloin pork chops, is high, then a workpiece that may be classified as one of multiple types (per product specifications) may be classified as the type of chop that is in higher demand. In that manner, a production run profit can be maximized.

The model output processing engine 310 may also include one or more modules configured to extract information from the output data for sending to the workpiece machine processing engine 312. For instance, the model output processing engine 310 may receive an image as an output of the machine learning model, and the model output processing engine 310 may extract various parameters from the output image (e.g., position, size, aspect ratio, outline, etc.).

The model output processing engine 310 sends post-processed output data to the workpiece machine processing engine 312 and/or saves any output data in the data store 316 for retrieval by the workpiece machine processing engine 312. The workpiece machine processing engine 312 uses information in the post-processed output data to determine a next step(s), if any, for processing the workpiece. For instance, if the post-processed output data indicates an outline for a bone in the workpiece, then the workpiece machine processing engine 312 may run a cutting module(s) which can instruct a cutter to cut around or otherwise avoid the bone when it reaches the cutting station. In another example, if the post-processed output data indicates a sciatic nerve location, the workpiece machine processing engine 312 may run a cutting module(s) to instruct the cutter to portion the workpiece to avoid or remove the sciatic nerve. Any suitable workpiece machine processing may be done accounting for the post-processed output data.

Before sending model output data to the model output processing engine 310, the output engine 512 may instead or additionally perform any necessary post-processing of the output data. For instance, post processing by the output engine 512 may include digitizing or reducing the data for efficient data transfer between the data processing computing device 108 and the machine computing device 106.

FIG. 21 is a block diagram that illustrates aspects of an exemplary computing device 600 appropriate for use as a computing device of the present disclosure. While multiple different types of computing devices were discussed above, the exemplary computing device 600 describes various elements that are common to many different types of computing devices. While FIG. 21 is described with reference to a computing device that is implemented as a device on a network, the description below is applicable to servers, personal computers, mobile phones, smart phones, tablet computers, embedded computing devices, and other devices that may be used to implement portions of examples of the present disclosure. Some examples of a computing device may be implemented in or may include an application-specific integrated circuit (ASIC), a field-programmable gate array (FPGA), or other customized device. Moreover, those of ordinary skill in the art and others will recognize that the computing device 600 may be any one of any number of currently available or yet to be developed devices.

In its most basic configuration, the computing device 600 includes at least one processor 602 and a system memory 610 connected by a communication bus 608. Depending on the exact configuration and type of device, the system memory 610 may be volatile or nonvolatile memory, such as read only memory (“ROM”), random access memory (“RAM”), EEPROM, flash memory, or similar memory technology. Those of ordinary skill in the art and others will recognize that system memory 610 typically stores data and/or program modules that are immediately accessible to and/or currently being operated on by the processor 602. In this regard, the processor 602 may serve as a computational center of the computing device 600 by supporting the execution of instructions.

As further illustrated in FIG. 21, the computing device 600 may include a network interface 606 comprising one or more components for communicating with other devices over a network. Examples of the present disclosure may access basic services that utilize the network interface 606 to perform communications using common network protocols. The network interface 606 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 606 illustrated in FIG. 6 may represent one or more wireless interfaces or physical communication interfaces described and illustrated above with respect to particular components of the computing device 600.

In the example depicted in FIG. 21, the computing device 600 also includes a storage medium 604. However, services may be accessed using a computing device that does not include means for persisting data to a local storage medium. Therefore, the storage medium 604 depicted in FIG. 21 is represented with a dashed line to indicate that the storage medium 604 is optional. In any event, the storage medium 604 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 602, system memory 610, communication bus 608, storage medium 604, and network interface 606 are known and commercially available. For ease of illustration and because it is not important for an understanding of the claimed subject matter, FIG. 21 does not show some of the typical components of many computing devices. In this regard, the computing device 600 may include input devices, such as a keyboard, keypad, mouse, microphone, touch input device, touch screen, tablet, and/or the like. Such input devices may be coupled to the computing device 600 by wired or wireless connections including RF, infrared, serial, parallel, Bluetooth, Bluetooth low energy, USB, or other suitable connections protocols using wireless or physical connections. Similarly, the computing device 600 may also include output devices such as a display, speakers, printer, etc. Since these devices are well known in the art, they are not illustrated or described further herein.

While the concepts of the present disclosure are susceptible to various modifications and alternative forms, specific examples thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one example,” “an example,” “an example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “up”, “down”, “left”, “right”, “first”, “second”, etc., in the present disclosure is meant to provide orientation for the reader with reference to the drawings and is not intended to be the required orientation of the components or graphical images or to impart orientation limitations into the claims.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative FIGS. Additionally, the inclusion of a structural or method feature in a particular FIG. is not meant to imply that such feature is required in all examples and, in some examples, it may not be included or may be combined with other features.

The present application may include modifiers such as the words “generally,” “approximately,” “about”, or “substantially.” These terms are meant to serve as modifiers to indicate that, for instance, the “dimension,” “shape,” “temperature,” “time,” or other physical parameter in question need not be exact, but may vary as long as the function that is required to be performed can be carried out.

As used herein, the terms “about”, “approximately,” etc., in reference to a number, is used herein to include numbers that fall within a range of 10%, 5%, or 1% in either direction (greater than or less than) the number unless otherwise stated or otherwise evident from the context (except where such number would exceed 100% of a possible value).

Where electronic or software components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Headings of sections provided in this patent application and the title of this patent application are for convenience only and are not to be taken as limiting the disclosure in any way.

While preferred examples of the present invention have been shown and described herein, it will be apparent to those skilled in the art that such examples are provided by way of example only. Numerous variations, changes, and substitutions will now occur to those skilled in the art without departing from the invention. Various alternatives to the examples of the invention described herein may be employed in practicing the invention. It is intended that the following claims define the scope of the invention and that methods and structures within the scope of these claims and their equivalents be covered.

### LISTING OF INNOVATIONS

Clause 1. A computer-implemented method of optimizing machine processing of a workpiece, the method comprising: receiving, by a computing device, at least one sensor input regarding a workpiece; performing, by a computing device, pre-processing of the at least one sensor input for at least one of efficient transfer to another computing device and optimal use in one or more machine learning models; executing, by a computing device, one or more machine learning models to output requested information regarding the workpiece based on data in the at least one sensor input; receiving and processing, by a computing device, the output; and controlling at least one aspect of the machine processing of the workpiece, by a computing device, in response to the processed output.

Clause 2. The method of Clause 1, wherein execution of the one or more machine learning models is carried out by an edge computing device, and wherein controlling at least one aspect of the machine processing of the workpiece in response to the processed output is carried out by a machine computer of a workpiece processing system configured to carry out at least one aspect of processing the workpiece.

Clause 3. The method of Clause 1 or 2, further comprising verifying, by a computing device, a machine learning model output corresponds to the at least one sensor input.

Clause 4. The method of Clause 1, 2, or 3, further comprising identifying, by a computing device, the machine learning model with a unique identifier in a communication including the at least one sensor input.

Clause 5. The method of Clause 1, further comprising controlling, by a computing device, a high-speed waterjet cutter to perform at least one of portioning, trimming, and cutting the workpiece in response to the processed output.

Clause 6. The method of Clause 1, wherein pre-processing includes at least one of formatting the at least one sensor input, generating views from the at least one sensor input, formatting views generated from the at least one sensor input, packaging views generated from the at least one sensor input for efficient transfer to another computing device, condensing views generated from the at least one sensor input for efficient transfer to another computing device, and transposing views generated from the at least one sensor input for efficient transfer to another computing device.

Clause 7. The method of Clause 1, wherein pre-processing includes at least one of transforming the at least one sensor input, re-sizing the at least one sensor input, labeling the at least one sensor input, and augmenting the at least one sensor input.

Clause 8. The method of Clause 1, wherein the at least one sensor input is an image of the workpiece, and wherein pre-processing includes at least one of gray-scaling the image, translating the image, rotating the image, scaling/re-sizing the image, adjusting contrast of the image, changing the contrast of the image, and adapting the image to certain model constraints.

Clause 9. The method of Clause 1, wherein the one or more machine learning models, after receiving at least one image of the workpiece as input, are configured to perform at least one of: generating at least one of workpiece classification and a classification probability score of at least one possible type of workpiece for the workpiece; generating a region of interest in an image of the workpiece; and generating an outline in an image of the workpiece of at least one object or feature of the workpiece.

Clause 10. The method of Clause 9, wherein the one or more machine learning models include a workpiece classification machine learning model, and wherein the workpiece classification machine learning model includes a convolutional neural network.

Clause 11. The method of Clause 9, wherein the one or more machine learning models include an image segmentation machine learning model configured to identify features of a workpiece, and wherein the image segmentation machine learning model includes a fully convolutional network.

Clause 12. The method of Clause 11, further comprising: generating, with a computing device, at least first and second binary masks that correspond to at least first and second features of the workpiece within a single input image; executing, with a computing device, a mask combiner engine to combine the at least first and second binary masks into a single multi-class mask; and training the image segmentation machine learning model, with a computing device, using the single multi-class mask.

Clause 13. The method of Clause 1, further comprising: receiving, with a computing device, images of first and second opposing surfaces of the workpiece; executing, with a computing device, an image segmentation machine learning model to generate a first output including an outline in an image of the first surface of the workpiece of at least one object or feature of the workpiece; executing, with a computing device, an image segmentation machine learning model to generate a second output including an outline in an image of the second surface of the workpiece of at least one object or feature of the workpiece; correlating, with a computing device, the at least one object or feature outlined in the image of the first surface of the workpiece with the at least one object or feature outlined in the image of the second surface of the workpiece; generating, with a computing device, a 3D model of the workpiece using the first and second outputs, the 3D model showing correlated at least one objects or features extending between the first and second opposing surfaces of the workpiece; and controlling at least one aspect of the processing of the workpiece, by a computing device, in response to the processed output.

Clause 14. The method of Clause 13, wherein generating, by a computing device, a 3D model of the workpiece using the first and second outputs includes: assigning X-Y coordinates to outlines of the least one objects or features extending between the first and second opposing surfaces of the workpiece; aligning the outlines of the least one objects or features extending between the first and second opposing surfaces of the workpiece; and at least one of: extrapolating the least one objects or features extending between the first and second opposing surfaces of the workpiece through a thickness of the workpiece; and extrapolating density data from the first surface of the workpiece down to the second opposing surface of the workpiece to estimate a shape of the second surface including any voids.

Clause 15. The method of Clause 13 or 14, wherein the image of the first surface of the workpiece is an image of the top surface of the workpiece, and the image of the second surface of the workpiece is an image of a top surface of a prior cut workpiece.

Clause 16. The method of Clause 15, wherein the images of the top and bottom surfaces are height maps.

Clause 17. The method of Clause 13, 15, 14, or 16 further comprising defining for a workpiece processing system, with a computing device, cut paths of the workpiece based the least one objects or features identified in the 3D model.

Clause 18. The method of Clause 13, 15, 14, 16, or 17, further comprising defining, with a computing device, at least a third surface of the workpiece at a Z coordinate between the first and second opposing surfaces of the workpiece based on the 3D model.

Clause 19. The method of Clause 13, 15, 14, 16, 17, or 18, further comprising executing, with a computing device, a workpiece classification machine learning model to generate at least one of a workpiece classification and a classification probability score of at least one possible type of workpiece for the workpiece as output using the 3D model of the workpiece as input.

Clause 20. The method of Clause 19, wherein receiving and processing, by a computing device, the output of a classification probability score includes categorizing the workpiece based on at least one of first and second classification probability scores for the workpiece using a demand for a first type of workpiece corresponding to the first classification probability score and a demand for a second type of workpiece corresponding to the second classification probability score.

Clause 21. The method of Clause 9, wherein generating, with a computing device, a classification probability score of at least one possible type of workpiece for the workpiece includes at least one of: providing a label for the at least one possible type of workpiece if the classification probability score exceeds a minimum threshold; providing a list of first and second possible types of workpieces for the workpiece based on a first and second highest classification probability scores; and providing a list of possible types of workpieces for the workpiece and corresponding classification probability scores for each type.

Clause 22. The method of Clause 9 or 21, wherein receiving and processing, by a computing device, the output of a classification probability score of at least one possible type of workpiece for the workpiece includes categorizing the workpiece based on at least one of the classification probability score and a demand for the at least one possible type of workpiece.

Clause 23. The method of Clause 22, further comprising performing, with a workpiece processing system, at least one of cutting, portioning, trimming, sorting, and packaging the workpiece based on its categorized type.

Clause 24. The method of Clause 9, wherein generating a region of interest in an image of the workpiece includes at least one of: superimposing a substantially largest inscribing circle on an image of the workpiece in a fatty region of a steak likely to include a sciatic nerve; and superimposing an outline on an image of the workpiece defining a likely peak height portion of the workpiece.

Clause 25. The method of Clause 24, wherein the one or more machine learning models configured to generate a region of interest in an image of the workpiece by superimposing a substantially largest inscribing circle on an image of the workpiece in a fatty region of a steak likely to include a sciatic nerve are trained to manage class imbalance by at least one of: weighting a positive class representing a fatty region of a steak likely to include a sciatic nerve, more than a negative class representing regions other than the fatty region of the steak likely to include the sciatic nerve, and penalizing the model when it misses the positive class; oversampling images with the positive class; and undersampling images that do not contain the positive class.

Clause 26. The method of Clause 9, wherein the workpiece is a piece of poultry, and wherein generating a region of interest in an image of the piece of poultry includes at least one of: superimposing an outline on an image of the piece of poultry surrounding a substantially flat peak height portion of a poultry breast; and superimposing an outline on an image of the piece of poultry surrounding a portion of a caudal ridge of the piece of poultry for measuring height and/or slope of the caudal ridge relevant to assessment of woody poultry.

Clause 27. The method of Clause 9, wherein the one or more machine learning models configured to generate a region of interest in an image of the workpiece include an EfficientNet (ENet) semantic binary segmentation model.

Clause 28. The method of Clause 9, wherein generating an outline in an image of the workpiece of at least one object or feature of the workpiece includes outlining at least one of a bone(s), a fat/lean boundary, an edge of the workpiece, a perimeter of the workpiece, a bottom surface of the workpiece, and cut lines of the workpiece.

Clause 29. The method of Clause 9, wherein generating an outline in an image of the workpiece of at least one object or feature of the workpiece includes outputting a multi-class output image including outlines of at least two types of features.

Clause 30. The method of Clause 9, further comprising: generating an outline in an image of a workpiece containing a poultry thigh including an outline of a mid-section of the poultry thigh and an overall outline of the poultry thigh; and cutting, with a workpiece processing system, fat caps off the poultry thigh based on the outline of the mid-section of the poultry thigh.

Clause 31. The method of Clause 9, wherein generating an outline in an image of the workpiece of at least one object or feature of the workpiece includes generating an outline of a meat section of a workpiece, excluding extraneous fat and stringy pieces, and further comprising: cutting, with a workpiece processing system, extraneous fat and stringy pieces based on the outline of the meat section of the workpiece.

Clause 32. The method of Clause 9 or 28, wherein the image of the workpiece is generated when the workpiece is on an open mesh, metal belt.

Clause 33. The method of Clause 9, 28, or 32, wherein the at least one image of the workpiece includes an x-ray image and an optical image taken substantially simultaneously.

Clause 34. The method of any of Clauses 1-33, wherein the at least one sensor input includes at least one of an X-ray scan, an optical image, an optical encoder input, a temperature measurement, and a weight measurement.

Clause 35. A system, comprising: a machine computing device, comprising: at least one processor and a non-transitory computer-readable medium; wherein the non-transitory computer-readable medium has computer-executable instructions stored thereon; and wherein the instructions, in response to execution by the at least one processor, cause the machine computing device to perform actions comprising: generating at least one sensor input related to machine processing of a workpiece; and an edge computing device, comprising: at least one processor and a non-transitory computer-readable medium; wherein the non-transitory computer-readable medium has computer-executable instructions stored thereon; wherein the instructions, in response to execution by the at least one processor, cause the edge computing device to perform actions comprising: receiving the at least one sensor input from the machine computing device; executing one or more machine learning models to output requested information regarding the workpiece based on data in the at least one sensor input; and wherein the instructions of the machine computing device, in response to execution by the at least one processor, cause the machine computing device to perform actions further comprising: receiving and processing the output; and controlling at least one aspect of the machine processing of the workpiece in response to the processed output.

Clause 36. The system of Clause 35, wherein the machine computing device controls a high-speed waterjet cutter to perform at least one of portioning, trimming, and cutting the workpiece.

Clause 37. The system of Clause 35, wherein the instructions in the non-transitory computer-readable medium of the machine computing device, in response to execution by the at least one processor, cause the machine computing device to perform actions further comprising: pre-processing of the at least one sensor input for at least one of efficient transfer to the edge computing device and optimal use in the one or more machine learning models.

Clause 38. The system of Clause 37, wherein pre-processing includes at least one of formatting the at least one sensor input, generating views from the at least one sensor input, formatting views generated from the at least one sensor input, packaging views generated from the at least one sensor input for efficient transfer to another computing device, condensing views generated from the at least one sensor input for efficient transfer to another computing device, and transposing views generated from the at least one sensor input for efficient transfer to another computing device.

Clause 39. The system of Clause 37 or 38, wherein pre-processing includes at least one of transforming the at least one sensor input, re-sizing the at least one sensor input, labeling the at least one sensor input, and augmenting the at least one sensor input.

Clause 40. The system of Clause 35, 36, 37, 38, or 39, wherein the at least one sensor input is an image of the workpiece, and wherein pre-processing includes at least one of gray-scaling the image, translating the image, rotating the image, scaling/re-sizing the image, adjusting contrast of the image, changing the contrast of the image, and adapting the image to certain model constraints.

Clause 41. The system of Clause 35, 36, 37, 38, 39, or 40, wherein the instructions in the non-transitory computer-readable medium of the machine computing device, in response to execution by the at least one processor, cause the machine computing device to perform actions further comprising: performing at least one of cutting, portioning, trimming, sorting, and packaging the workpiece in response to the processed output.

Clause 42. The system of Clause 35, 36, 37, 38, 39, 40, or 41, wherein the at least one sensor input includes at least one of an X-ray scan, an optical image, an optical encoder input, a temperature measurement, and a weight measurement.

Clause 43. The system of Clause 35, 36, 37, 38, 39, 40, 41, or 42, wherein the instructions in the non-transitory computer-readable medium of the machine computing device, in response to execution by the at least one processor, cause the machine computing device to perform actions further comprising: verifying a machine learning model output corresponds to the at least one sensor input.

Clause 44. The system of Clause 43, wherein the instructions in the non-transitory computer-readable medium of the machine computing device, in response to execution by the at least one processor, cause the machine computing device to perform actions further comprising: identifying the machine learning model with a unique identifier in a communication including the at least one sensor input.

Clause 45. The system of Clause 35, 36, 37, 38, 39, 40, 41, 42, 43, or 44 wherein the one or more machine learning models, after receiving at least one image of the workpiece as input, are configured to perform at least one of: generating a classification probability score of at least one possible type of workpiece for the workpiece; generating a region of interest in an image of the workpiece; and generating an outline in an image of the workpiece of at least one object or feature of the workpiece.

Clause 46. The system of Clause 35, 36, 37, 38, 39, 40, 41, 42, 43, 44, or 45, wherein the instructions in the non-transitory computer-readable medium of at least one of the machine computing device and the edge computing device, in response to execution by the at least one respective processor, cause the at least one of the machine computing device and the edge computing device to perform actions further comprising: receiving images of first and second opposing surfaces of the workpiece; executing an image segmentation machine learning model to generate a first output including an outline in an image of the first surface of the workpiece of at least one object or feature of the workpiece; executing an image segmentation machine learning model to generate a second output including an outline in an image of the second surface of the workpiece of at least one object or feature of the workpiece; correlating the at least one object or feature outlined in the image of the first surface of the workpiece with the at least one object or feature outlined in the image of the second surface of the workpiece; generating a 3D model of the workpiece using the first and second outputs, the 3D model showing correlated at least one objects or features extending between the first and second opposing surfaces of the workpiece; and controlling at least one aspect of the machine processing of the workpiece, by a computing device, in response to the processed output.

Clause 47. The system of Clause 46, wherein for generating a 3D model of the workpiece using the first and second outputs, the instructions in the non-transitory computer-readable medium of the at least one of the machine computing device and the edge computing device, in response to execution by the at least one processor, cause the at least one of the machine computing device and the edge computing device to perform actions further comprising: assigning X-Y coordinates to outlines of the least one objects or features extending between the first and second opposing surfaces of the workpiece; aligning the outlines of the least one objects or features extending between the first and second opposing surfaces of the workpiece; and at least one of: extrapolating the least one objects or features extending between the first and second opposing surfaces of the workpiece through a thickness of the workpiece; and extrapolating density data from the first surface of the workpiece down to the second opposing surface of the workpiece to estimate a shape of the second surface including any voids.

Clause 48. The system of Clause 46 or 47, wherein the image of the first surface of the workpiece is an image of the top surface of the workpiece, and the image of the second surface of the workpiece is an image of a top surface of a prior cut workpiece.

Clause 49. The system of Clause 48, wherein the images of the top and bottom surfaces are height maps.

Clause 50. The system of Clause 46, 47, 48, or 49, wherein the instructions in the non-transitory computer-readable medium of the machine computing device, in response to execution by the at least one processor, cause the machine computing device to perform actions further comprising: defining, for a workpiece processing system, cut paths of the workpiece based the least one objects or features identified in the 3D model.

Clause 51. The system of Clause 46, 47, 48, 49, or 50, wherein the instructions in the non-transitory computer-readable medium of at least one of the machine computing device and the edge computing device, in response to execution by the at least one respective processor, cause the at least one of the machine computing device and the edge computing device to perform actions further comprising: defining at least a third surface of the workpiece at a Z coordinate between the first and second opposing surfaces of the workpiece based on the 3D model.

Clause 52. The system of Clause 46, 47, 48, 49, 50, or 51, wherein the instructions in the non-transitory computer-readable medium of the edge computing device, in response to execution by the at least one processor, cause the edge computing device to perform actions further comprising: executing a workpiece classification machine learning model to generate at least one of a workpiece classification and a classification probability score of at least one possible type of workpiece for the workpiece as output using the 3D model of the workpiece as input.

Clause 53. The system of Clause 52, wherein the instructions in the non-transitory computer-readable medium of at least one of the machine computing device and the edge computing device, in response to execution by the at least one respective processor, cause the at least one of the machine computing device and the edge computing device to perform actions further comprising: receiving and processing the output of a classification probability score; and categorizing the workpiece based on at least one of first and second classification probability scores for the workpiece using a demand for a first type of workpiece corresponding to the first classification probability score and a demand for a second type of workpiece corresponding to the second classification probability score.

Clause 54. The system of Clause 45, wherein generating a classification probability score of at least one possible type of workpiece for the workpiece includes at least one of: providing a label for the at least one possible type of workpiece if the classification probability score exceeds a minimum threshold; providing a list of first and second possible types of workpieces for the workpiece based on a first and second highest classification probability scores; and providing a list of possible types of workpieces for the workpiece and corresponding classification probability scores for each type.

Clause 55. The system of Clause 45 or 54, wherein the instructions in the non-transitory computer-readable medium of the machine computing device, in response to execution by the at least one processor, cause the machine computing device to perform actions further comprising: categorizing the workpiece based on at least one of the classification probability score and a demand for the at least one possible type of workpiece.

Clause 56. The system of Clause 55, wherein the instructions in the non-transitory computer-readable medium of the machine computing device, in response to execution by the at least one processor, cause the machine computing device to perform actions further comprising: performing at least one of cutting, portioning, trimming, sorting, and packaging the workpiece based on its categorized type.

Clause 57. The system of Clause 45, wherein generating a region of interest in an image of the workpiece includes at least one of: superimposing a substantially largest inscribing circle on an image of the workpiece in a fatty region of a steak likely to include a sciatic nerve; and superimposing an outline on an image of the workpiece defining a likely peak height portion of the workpiece.

Clause 58. The system of Clause 45, wherein the workpiece is a piece of poultry, and wherein generating a region of interest in an image of the piece of poultry includes at least one of: superimposing an outline on an image of the piece of poultry surrounding a substantially flat peak height portion of a poultry breast; and superimposing an outline on an image of the piece of poultry surrounding a portion of a caudal ridge of the piece of poultry for measuring height and/or slope of the caudal ridge relevant to assessment of woody poultry.

Clause 59. The system of Clause 45, wherein generating an outline in an image of the workpiece of at least one object or feature of the workpiece includes outlining at least one of a bone(s), a fat/lean boundary, an edge of the workpiece, a perimeter of the workpiece, a bottom surface of a workpiece, and cut lines of the workpiece.

Clause 60. The system of Clause 45 or 59, wherein the image of the workpiece is generated when the workpiece is on an open mesh, metal belt.

Clause 61. The system of Clause 45, 59, or 60, wherein the at least one image of the workpiece includes an x-ray image and an optical image taken substantially simultaneously.

Clause 62. The system of any of Clauses 35-61, wherein the at least one sensor input includes at least one of an X-ray scan, an optical image, an optical encoder input, a temperature measurement, and a weight measurement

The embodiments of the invention in which an exclusive property or privilege is claimed are defined as follows:

1. A computer-implemented method of optimizing machine processing of a workpiece, the method comprising:
receiving, by a computing device, at least one sensor input regarding a workpiece;
performing, by a computing device, pre-processing of the at least one sensor input for at least one of efficient transfer to another computing device and optimal use in one or more machine learning models;
executing, by a computing device, one or more machine learning models to output requested information regarding the workpiece based on data in the at least one sensor input;
receiving and processing, by a computing device, the output; and
controlling at least one aspect of the machine processing of the workpiece, by a computing device, in response to the processed output.

2. The method of claim 1, wherein execution of the one or more machine learning models is carried out by an edge computing device, and wherein controlling at least one aspect of the machine processing of the workpiece in response to the processed output is carried out by a machine computer of a workpiece processing system configured to carry out at least one aspect of processing the workpiece.

3. The method of claim 1, further comprising at least one of:
verifying, by a computing device, a machine learning model output corresponds to the at least one sensor input; and
identifying, by a computing device, the machine learning model with a unique identifier in a communication including the at least one sensor input.

4. The method of claim 1, wherein the one or more machine learning models, after receiving at least one image of the workpiece as input, are configured to perform at least one of:
generating at least one of workpiece classification and a classification probability score of at least one possible type of workpiece for the workpiece;
generating a region of interest in an image of the workpiece; and
generating an outline in an image of the workpiece of at least one object or feature of the workpiece.

5. The method of claim 4, wherein the one or more machine learning models include a workpiece classification machine learning model, and wherein the workpiece classification machine learning model includes a convolutional neural network.

6. The method of claim 4, wherein the one or more machine learning models include an image segmentation machine learning model configured to identify features of a workpiece, and wherein the image segmentation machine learning model includes a fully convolutional network.

7. The method of claim 6, further comprising:
generating, with a computing device, at least first and second binary masks that correspond to at least first and second features of the workpiece within a single input image;
executing, with a computing device, a mask combiner engine to combine the at least first and second binary masks into a single multi-class mask; and
training the image segmentation machine learning model, with a computing device, using the single multi-class mask.

8. The method of claim 1, further comprising:
receiving, with a computing device, images of first and second opposing surfaces of the workpiece;
executing, with a computing device, an image segmentation machine learning model to generate a first output including an outline in an image of the first surface of the workpiece of at least one object or feature of the workpiece;
executing, with a computing device, an image segmentation machine learning model to generate a second output including an outline in an image of the second surface of the workpiece of at least one object or feature of the workpiece;
correlating, with a computing device, the at least one object or feature outlined in the image of the first surface of the workpiece with the at least one object or feature outlined in the image of the second surface of the workpiece;
generating, with a computing device, a 3D model of the workpiece using the first and second outputs, the 3D model showing correlated at least one objects or features extending between the first and second opposing surfaces of the workpiece; and
controlling at least one aspect of the processing of the workpiece, by a computing device, in response to the processed output.

9. The method of claim 8, wherein generating, by a computing device, a 3D model of the workpiece using the first and second outputs includes:
assigning X-Y coordinates to outlines of the least one objects or features extending between the first and second opposing surfaces of the workpiece;
aligning the outlines of the least one objects or features extending between the first and second opposing surfaces of the workpiece; and
at least one of:
extrapolating the least one objects or features extending between the first and second opposing surfaces of the workpiece through a thickness of the workpiece; and
extrapolating density data from the first surface of the workpiece down to the second opposing surface of the workpiece to estimate a shape of the second surface including any voids.

10. The method of claim 9, wherein the image of the first surface of the workpiece is an image of the top surface of the workpiece, and the image of the second surface of the workpiece is an image of a top surface of a prior cut workpiece.

11. The method of claim 10, further comprising defining for a workpiece processing system, with a computing device, cut paths of the workpiece based the least one objects or features identified in the 3D model.

12. The method of claim 10, further comprising executing, with a computing device, a workpiece classification machine learning model to generate at least one of a workpiece classification and a classification probability score of at least one possible type of workpiece for the workpiece as output using the 3D model of the workpiece as input.

13. The method of claim 12, wherein receiving and processing, by a computing device, the output of a classification probability score includes categorizing the workpiece based on at least one of first and second classification probability scores for the workpiece using a demand for a first type of workpiece corresponding to the first classification probability score and a demand for a second type of workpiece corresponding to the second classification probability score.

14. The method of claim 4, wherein generating, with a computing device, a classification probability score of at least one possible type of workpiece for the workpiece includes at least one of:
providing a label for the at least one possible type of workpiece if the classification probability score exceeds a minimum threshold;
providing a list of first and second possible types of workpieces for the workpiece based on a first and second highest classification probability scores; and
providing a list of possible types of workpieces for the workpiece and corresponding classification probability scores for each type.

15. The method of claim 14, further comprising:
receiving and processing, by a computing device, the output of a classification probability score of at least one possible type of workpiece for the workpiece including categorizing the workpiece based on at least one of the classification probability score and a demand for the at least one possible type of workpiece; and
performing, with a workpiece processing system, at least one of cutting, portioning, trimming, sorting, and packaging the workpiece based on its categorized type.

16. The method of claim 4, wherein generating a region of interest in an image of the workpiece includes at least one of:
superimposing a substantially largest inscribing circle on an image of the workpiece in a fatty region of a steak likely to include a sciatic nerve; and
superimposing an outline on an image of the workpiece defining a likely peak height portion of the workpiece.

17. The method of claim 16, wherein the one or more machine learning models configured to generate a region of interest in an image of the workpiece by superimposing a substantially largest inscribing circle on an image of the workpiece in a fatty region of a steak likely to include a sciatic nerve are trained to manage class imbalance by at least one of:
weighting a positive class representing a fatty region of a steak likely to include a sciatic nerve, more than a negative class representing regions other than the fatty region of the steak likely to include the sciatic nerve, and penalizing the model when it misses the positive class;
oversampling images with the positive class; and
undersampling images that do not contain the positive class.

18. The method of claim 4, wherein the one or more machine learning models configured to generate a region of interest in an image of the workpiece include an EfficientNet (ENet) semantic binary segmentation model.

19. The method of claim 4, wherein generating an outline in an image of the workpiece of at least one object or feature of the workpiece includes at least one of:
outlining at least one of a bone(s), a fat/lean boundary, an edge of the workpiece, a perimeter of the workpiece, a bottom surface of the workpiece, and cut lines of the workpiece; and
outputting a multi-class output image including outlines of at least two types of features.

20. A system, comprising:
a machine computing device, comprising:
at least one processor and a non-transitory computer-readable medium;
wherein the non-transitory computer-readable medium has computer-executable instructions stored thereon; and
wherein the instructions, in response to execution by the at least one processor, cause the machine computing device to perform actions comprising:
generating at least one sensor input related to machine processing of a workpiece; and
an edge computing device, comprising:
at least one processor and a non-transitory computer-readable medium;
wherein the non-transitory computer-readable medium has computer-executable instructions stored thereon;
wherein the instructions, in response to execution by the at least one processor, cause the edge computing device to perform actions comprising:
receiving the at least one sensor input from the machine computing device;
executing one or more machine learning models to output requested information regarding the workpiece based on data in the at least one sensor input; and
wherein the instructions of the machine computing device, in response to execution by the at least one processor, cause the machine computing device to perform actions further comprising:
receiving and processing the output; and
controlling at least one aspect of the machine processing of the workpiece in response to the processed output.
